(19) United States
(12) Patent Application Publication
(10) Pub. No.: US 2024/0340662 A1
(43) Pub. Date: Oct. 10, 2024

(54) RADIO RESOURCE CONTROL MODEL DELIVERY

(71) Applicant: QUALCOMM Incorporated, San Diego, CA (US)

(72) Inventors: Rajeev KUMAR, San Diego, CA (US); Aziz GHOLMIEH, Del Mar, CA (US)

(21) Appl. No.: 18/624,691

(22) Filed: Apr. 2, 2024

Related U.S. Application Data
(60) Provisional application No. 63/494,124, filed on Apr. 4, 2023.

(51) Int. Cl. H04W 24/02; H04W 36/08; H04W 76/19; H04W 76/20; H04W 76/30

(52) U.S. Cl. CPC H04W 24/02; H04W 36/08; H04W 76/19; H04W 76/20; H04W 76/30

(57) ABSTRACT

Various aspects of the present disclosure generally relate to wireless communication. In some aspects, a user equipment (UE) may communicate with one of a first network node or a second network node to update available model information in a UE context at one or more of the first network node or the second network node. The UE may receive, from one of the first network node or the second network node, a model transfer via radio resource control (RRC) signaling. Numerous other aspects are described.

### CROSS-REFERENCE TO RELATED APPLICATION

This Patent Application claims priority to U.S. Provisional Patent Application No. 63/494,124, filed on Apr. 4, 2023, entitled “RADIO RESOURCE CONTROL MODEL DELIVERY,” and assigned to the assignee hereof. The disclosure of the prior Application is considered part of and is incorporated by reference into this Patent Application.

### FIELD OF THE DISCLOSURE

Aspects of the present disclosure generally relate to wireless communication and to techniques and apparatuses for artificial intelligence and/or machine learning model delivery via radio resource control signaling.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a user equipment (UE). The method may include communicating with one of a first network node or a second network node to update available model information in a UE context at one or more of the first network node or the second network node. The method may include receiving, from one of the first network node or the second network node, a model transfer via radio resource control (RRC) signaling.

Some aspects described herein relate to a method of wireless communication performed by a network node. The method may include communicating with a UE. The method may include outputting, to the UE, a model transfer via RRC signaling; receiving a model release request from the UE; and outputting a model release instruction to the UE to configure the UE to release one or more models.

Some aspects described herein relate to a UE for wireless communication. The UE may include a memory and one or more processors coupled to the memory. The one or more processors may be configured to communicate with one of a first network node or a second network node to update available model information in a UE context at one or more of the first network node or the second network node. The one or more processors may be configured to receive, from one of the first network node or the second network node, a model transfer via RRC signaling.

Some aspects described herein relate to a network node for wireless communication. The network node may include a memory and one or more processors coupled to the memory. The one or more processors may be configured to communicate with a UE. The one or more processors may be configured to output, to the UE, an artificial intelligence or machine learning (AI/ML) model transfer via RRC signaling; receive an AI/ML model release request from the UE; and output an AI/ML model release instruction to the UE to configure the UE to release one or more AI/ML models.

Some aspects described herein relate to a non-transitory computer-readable medium that stores a set of instructions for wireless communication by a UE. The set of instructions, when executed by one or more processors of the UE, may cause the UE to communicate with one of a first network node or a second network node to update available model information in a UE context at one or more of the first network node or the second network node. The set of instructions, when executed by one or more processors of the UE, may cause the UE to receive, from one of the first network node or the second network node, a model transfer via RRC signaling.

Some aspects described herein relate to a non-transitory computer-readable medium that stores a set of instructions for wireless communication by a network node. The set of instructions, when executed by one or more processors of the network node, may cause the network node to communicate with a UE. The set of instructions, when executed by one or more processors of the network node, may cause the network node to output, to the UE, an AI/ML model transfer via RRC signaling; receive an AI/ML model release request from the UE; and output an AI/ML model release instruction to the UE to configure the UE to release one or more AI/ML models.

Some aspects described herein relate to an apparatus for wireless communication. The apparatus may include means for communicating with one of a first network node or a second network node to update available model information in a UE context at one or more of the first network node or the second network node. The apparatus may include means for receiving, from one of the first network node or the second network node, a model transfer via RRC signaling.

Some aspects described herein relate to an apparatus for wireless communication. The apparatus may include means for communicating with a UE. The apparatus may include means for outputting, to the UE, an AI/ML model transfer via RRC signaling; means for receiving an AI/ML model release request from the UE; and means for outputting an AI/ML model release instruction to the UE to configure the UE to release one or more AI/ML models.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 illustrates an example of a wireless network (e.g., wireless network) in which a UE may support additional communication modes, in accordance with the present disclosure.

FIG. 5 is a diagram illustrating an example architecture of a functional framework for radio access network intelligence enabled by data collection, in accordance with the present disclosure.

FIG. 6 is a diagram illustrating an example associated with artificial intelligence/machine learning (AI/ML) model delivery via radio resource control (RRC) signaling, in accordance with the present disclosure.

FIG. 7-19 are diagrams illustrating various examples associated with AI/ML model delivery via RRC signaling, in accordance with the present disclosure.

FIG. 20 is a diagram illustrating an example process performed, for example, by a UE, in accordance with the present disclosure.

FIG. 21 is a diagram illustrating an example process performed, for example, by a network node, in accordance with the present disclosure.

FIG. 22 is a diagram of an example apparatus for wireless communication, in accordance with the present disclosure.

FIG. 23 is a diagram of an example apparatus for wireless communication, in accordance with the present disclosure.

### DETAILED DESCRIPTION

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

A user equipment (UE) may be equipped with various models or model structures incorporating artificial intelligence (AI), such as a program that includes a machine learning (ML) or artificial neural network (ANN) model. An example ML model may include mathematical representations or define computing capabilities for making inferences from input data based on patterns or relationships identified in the input data. As used herein, the term “inferences” can include one or more of decisions, predictions, determinations, or values, which may represent outputs of the ML model. The computing capabilities may be defined in terms of certain parameters of the ML model, such as weights and biases. Weights may indicate relationships between certain input data and certain outputs of the ML model, and biases are offsets which may indicate a starting point for outputs of the ML model. An example ML model operating on input data may start at an initial output based on the biases and then update its output based on a combination of the input data and the weights. ML models may be deployed in one or more devices (for example, network entities and UEs) and may be configured to enhance various aspects of a wireless communication system. For example, an ML model may be trained to identify patterns or relationships in data corresponding to a network, a device, an air interface, or the like. An ML model may support operational decisions relating to one or more aspects associated with wireless communications devices, networks, or services. For example, an ML model may be utilized for supporting or improving aspects such as signal coding/decoding, network routing, energy conservation, transceiver circuitry controls, frequency synchronization, timing synchronization, channel state estimation, channel equalization, channel state feedback, modulation, demodulation, device positioning, beamforming, load balancing, operations and management functions, security, etc. There may be times, however, when a network node, such as a gNB, does not know which AI/ML models are available to the UE.

Some techniques and apparatuses described herein enable a UE to communicate with one of a first network node or a second network node to update available model information in a UE context at one or more of the first network node or the second network node, and receive, from one of the first network node or the second network node, a model transfer via radio resource control (RRC) signaling. As a result, the UE may communicate, to the first or second network node, which AI/ML models are available to the UE. If the UE lacks an AI/ML model for a particular feature or functionality, the network node may transfer the appropriate AI/ML model(s) to the UE.

Some techniques and apparatuses described herein enable a network node to communicate with a UE and output, to the UE, a model transfer via RRC signaling. As a result, the network node may know which AI/ML models are available to the UE and, when appropriate, transfer any needed AI/ML models to the UE.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

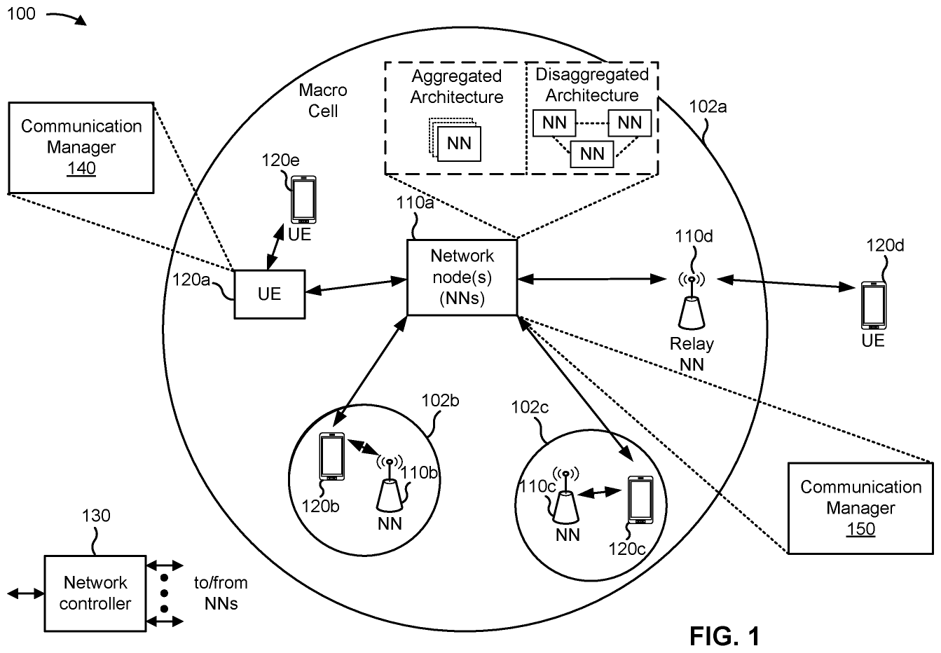

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a UE 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link The network nodes 110 may communicate with one another directly or indirectly via a wireless or wireline backhaul communication link In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may communicate with one of a first network node or a second network node to update available model information in a UE context at one or more of the first network node or the second network node; and receive, from one of the first network node or the second network node, a model transfer via RRC signaling. Additionally, or alternatively, the communication manager 140 may perform one or more other operations described herein.

In some aspects, the network node 110 may include a communication manager 150. As described in more detail elsewhere herein, the communication manager 150 may communicate with a UE; and output, to the UE, a model transfer via RRC signaling. Additionally, or alternatively, the communication manager 150 may perform one or more other operations described herein.

As indicated above, FIG. 1 is provided as an example. Other examples may differ from what is described with regard to FIG. 1.

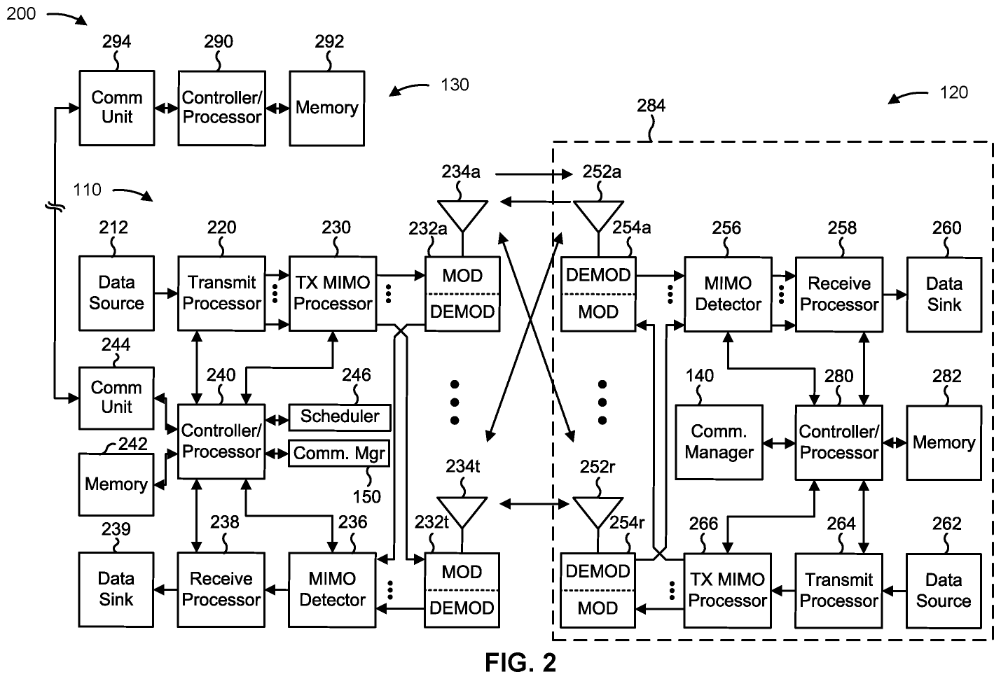

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

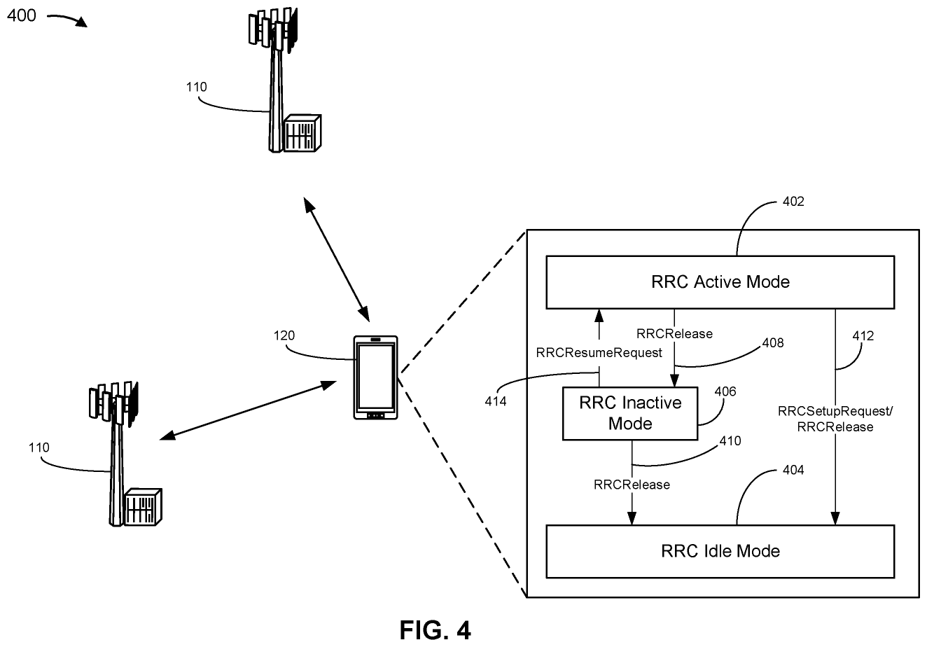

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 4-23).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 4-23).

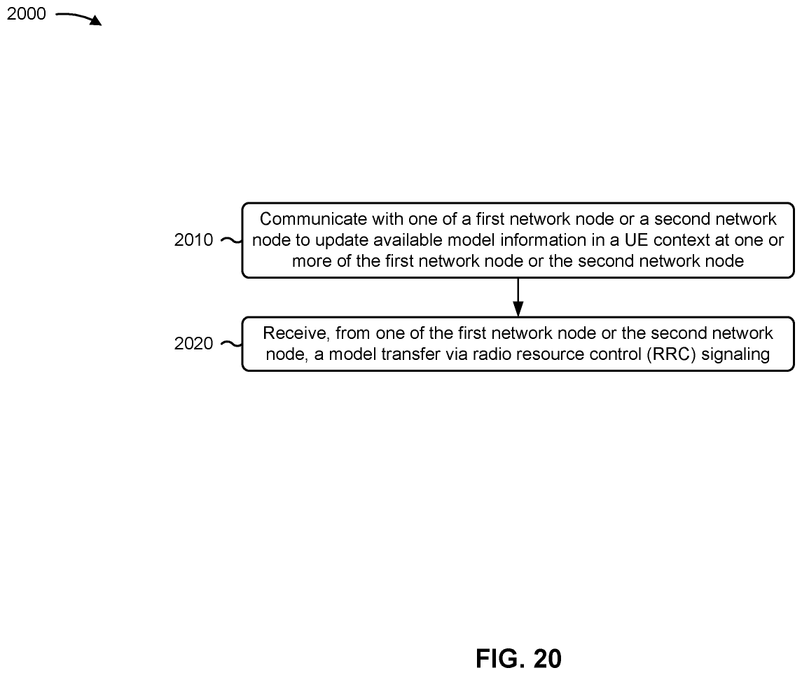

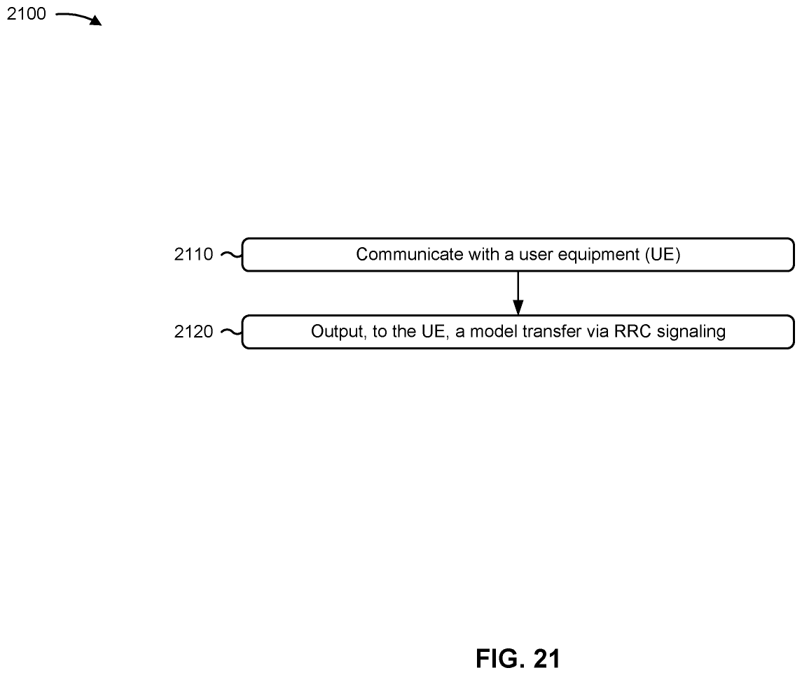

The controller/processor 240 of the network node 110, the controller/processor 280 of the UE 120, and/or any other component(s) of FIG. 2 may perform one or more techniques associated with AI/ML model delivery via RRC, as described in more detail elsewhere herein. For example, the controller/processor 240 of the network node 110, the controller/processor 280 of the UE 120, and/or any other component(s) of FIG. 2 may perform or direct operations of, for example, process 2000 of FIG. 20, process 2100 of FIG. 21, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 2000 of FIG. 20, process 2100 of FIG. 21, and/or other processes as described herein. In some examples, executing instructions may include running the instructions, converting the instructions, compiling the instructions, and/or interpreting the instructions, among other examples.

In some aspects, the UE 120 includes means for communicating with one of a first network node or a second network node to update available model information in a UE context at one or more of the first network node or the second network node; and/or means for receiving, from one of the first network node or the second network node, a model transfer via RRC signaling. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node 110 includes means for communicating with a UE 120; means for outputting, to the UE 120, a model transfer via RRC signaling; means for receiving a model release request from the UE; and means for outputting a model release instruction to the UE to configure the UE to release one or more models. The means for the network node 110 to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

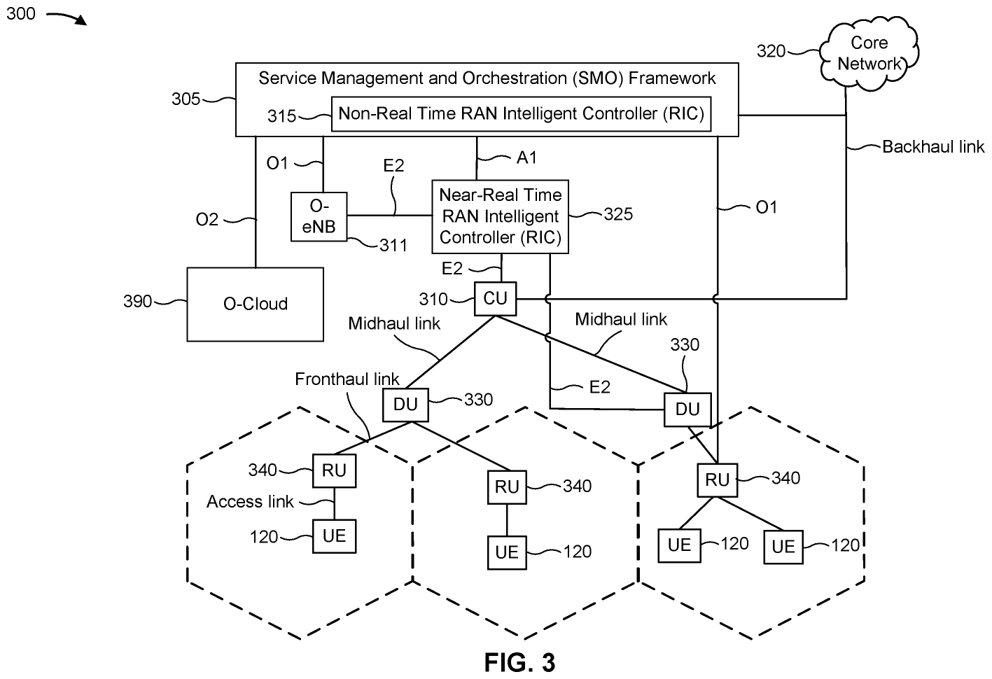

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include RRC functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (LCM) (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

FIG. 4 illustrates an example 400 of a wireless network (e.g., wireless network 100) in which a UE (e.g., a UE 120) may support additional communication modes, in accordance with the present disclosure. The UE may be communicatively connected with one or more network nodes 110 in the wireless network. For example, the UE may be connected to the one or more network nodes 110 in a dual connectivity configuration. In this case, a first network node 110 may serve the UE as a master node and a second network node 110 may serve the UE as a secondary node.

As illustrated in FIG. 4, the UE may support a connected communication mode (e.g., an RRC active mode 402), an idle communication mode (e.g., an RRC idle mode 404), and an inactive communication mode (e.g., an RRC inactive mode 406). RRC inactive mode 406 may functionally reside between RRC active mode 402 and RRC idle mode 404.

The UE may transition between different modes based at least in part on various commands and/or communications received from the one or more network nodes 110. For example, the UE may transition from RRC active mode 402 or RRC inactive mode 406 to RRC idle mode 404 based at least in part on receiving an RRCRelease communication (e.g., RRCRelease 408 for transitioning from the RRC active mode 402 to the RRC inactive mode 406 and RRCRelease 410 for transitioning from the RRC inactive mode 406 to the RRC idle mode 404). As another example, the UE may transition from RRC active mode 402 to RRC inactive mode 406 based at least in part on receiving an RRCRelease 408 with suspendConfig communication. As another example, the UE may transition from RRC idle mode 404 to RRC active mode 402 based at least in part on receiving an RRCSetupRequest communication 412. As another example, the UE may transition from RRC inactive mode 406 to RRC active mode 402 based at least in part on receiving an RRCResumeRequest communication 414.

When transitioning to RRC inactive mode 406, the UE and/or the one or more network nodes 110 may store a UE context (e.g., an access stratum (AS) context and/or higher-layer configurations). This permits the UE and/or the one or more network nodes 110 to apply the stored UE context when the UE transitions from RRC inactive mode 406 to RRC active mode 402 in order to resume communications with the one or more network nodes 110, which reduces latency of transitioning to RRC active mode 402 relative to transitioning to the RRC active mode 402 from RRC idle mode 404.

In some cases, the UE may communicatively connect with a new master node when transitioning from RRC idle mode 404 or RRC inactive mode 406 to RRC active mode 402 (e.g., a master node that is different from the last serving master node when the UE transitioned to RRC idle mode 404 or RRC inactive mode 406). In this case, the new master node may be responsible for identifying a secondary node for the UE in the dual connectivity configuration.

As indicated above, FIG. 4 is provided as an example. Other examples may differ from what is described with regard to FIG. 4.

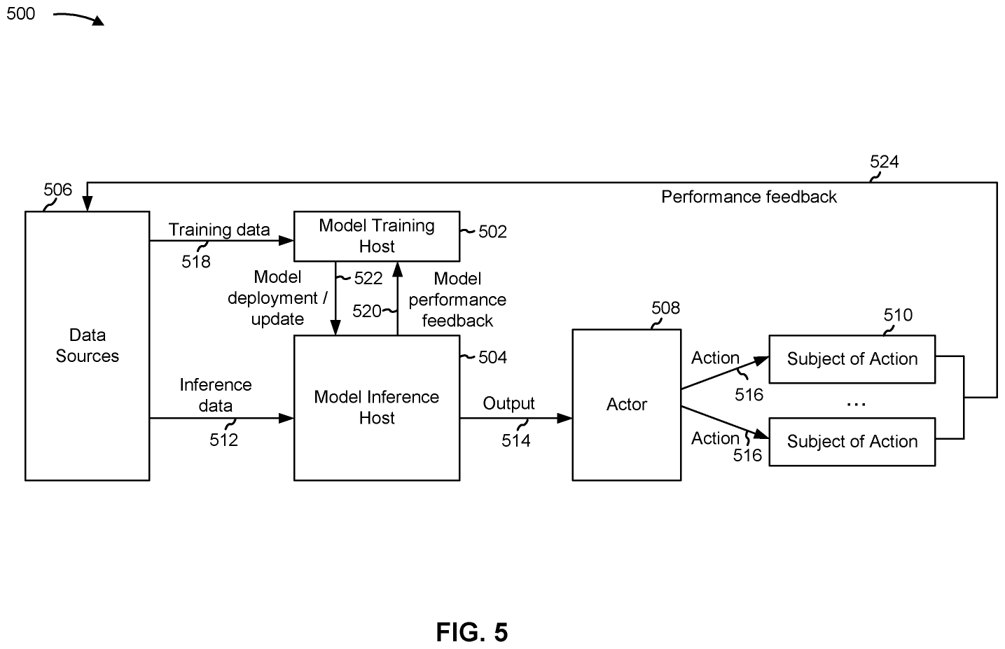

FIG. 5 is a diagram illustrating an example architecture 500 of a functional framework for radio access network (RAN) intelligence enabled by data collection, in accordance with the present disclosure. In some scenarios, the functional framework for RAN intelligence may be enabled by further enhancement of data collection through use cases and/or examples. For example, principles or algorithms for RAN intelligence enabled by AI/ML and the associated functional framework (e.g., the AI functionality and/or the input/output of the component for AI enabled optimization) have been utilized or studied to identify the benefits of AI enabled RAN through possible use cases (e.g., beam management, energy saving, load balancing, mobility management, and/or coverage optimization, among other examples). In one example, as shown by the architecture 500, a functional framework for RAN intelligence may include multiple logical entities, such as a model training host 502, a model inference host 504, data sources 506, and an actor 508.

The model inference host 504 may be configured to run an AI/ML model based on inference data 512 provided by the data sources 506, and the model inference host 504 may produce an output 514 (e.g., a prediction) with the inference data 512 input to the actor 508 and model performance feedback 520 to the model training host 502. The actor 508 may be an element or an entity of a core network or a RAN. For example, the actor 508 may be a UE, a network node, base station (e.g., a gNB), a CU, a DU, and/or an RU, among other examples. In addition, the actor 508 may also depend on the type of tasks performed by the model inference host 504, type of inference data 512 provided to the model inference host 504, and/or type of output produced by the model inference host 504. For example, if the output 514 from the model inference host 504 is associated with beam management, then the actor 508 may be a UE, a DU or an RU. In other examples, if the output 514 from the model inference host 504 is associated with Tx/Rx scheduling, then the actor 508 may be a CU or a DU.

After the actor 508 receives an output 514 from the model inference host 504, the actor 508 may determine whether to act based on the output 514. For example, if the actor 508 is a DU or an RU and the output 514 from the model inference host 504 is associated with beam management, the actor 508 may determine whether to change/modify a Tx/Rx beam based on the output 514. If the actor 508 determines to act based on the output 514, the actor 508 may indicate the action 516 to at least one subject of action 510. For example, if the actor 508 determines to change/modify a Tx/Rx beam for a communication between the actor 508 and the subject of action 510 (e.g., a UE 120), then the actor 508 may transmit a beam (re-)configuration or a beam switching indication to the subject of action 510. The actor 508 may modify its Tx/Rx beam based on the beam (re-)configuration, such as switching to a new Tx/Rx beam or applying different parameters for a Tx/Rx beam, among other examples. As another example, the actor 508 may be a UE and the output 514 from the model inference host 504 may be associated with beam management. For example, the output 514 may be one or more predicted measurement values for one or more beams. The actor 508 (e.g., a UE) may determine that a measurement report (e.g., a Layer 1 (L1) RSRP report) is to be transmitted to a network node 110.

The data sources 506 may also be configured for collecting data that is used as training data 518 for training an ML model or as inference data 512 for feeding an ML model inference operation. For example, the data sources 506 may collect data from one or more core network and/or RAN entities, which may include the subject of action 510, and provide the collected data to the model training host 502 for ML model training For example, after a subject of action 510 (e.g., a UE 120) receives a beam configuration from the actor 508, the subject of action 510 may provide performance feedback 524 associated with the beam configuration to the data sources 506, where the performance feedback 524 may be used by the model training host 502 for monitoring or evaluating the ML model performance, such as whether the output 514 (e.g., prediction) provided to the actor 508 is accurate. In some examples, if the output 514 provided by the actor 508 is inaccurate (or the accuracy is below an accuracy threshold), then the model training host 502 may determine to modify or retrain the ML model used by the model inference host, such as via an ML model deployment/update 522.

As indicated above, FIG. 5 is provided as an example. Other examples may differ from what is described with regard to FIG. 5.

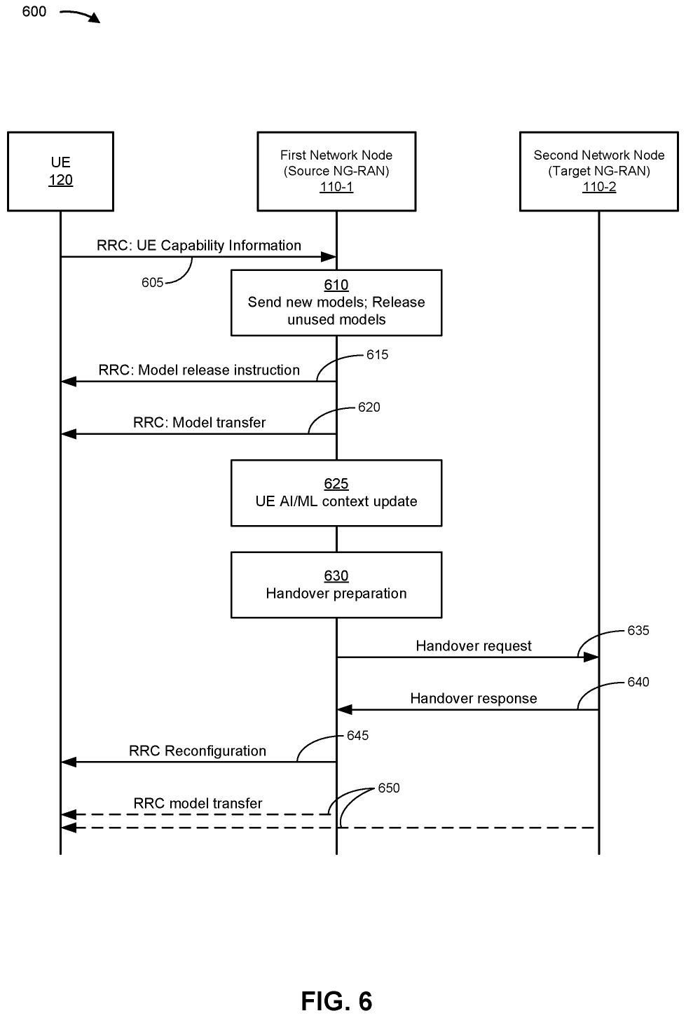

FIG. 6 is a diagram illustrating an example 600 associated with AI/ML model delivery via RRC signaling, in accordance with the present disclosure. As shown in FIG. 6, a first network node 110-1, a second network node 110-2, and a UE 120 may communicate with one another. The first network node 110-1 may be part of a source New Generation (NG) RAN (NG-RAN) in communication with the UE 120 prior to a handover execution (e.g., completion of a handover procedure). The second network node 110-2 may be part of a target NG-RAN in communication with the UE 120 after a handover procedure. The handover procedure may include a handover of the UE 120 from the source NG-RAN to the target NG-RAN.

As shown by reference number 605, the UE 120 may transmit, and the first network node 110-1 may receive, UE capability information via, for example, RRC signaling. The UE capability information may indicate, to the first network node 110-1, an amount of memory and other resources available to the UE 120.

As shown by reference number 610, the first network node 110-1 may determine whether to send new models to the UE 120, whether to instruct the UE 120 to release one or more models from a memory of the UE 120, and/or a combination thereof, among other examples. The first network node 110-1 may determine to instruct the UE 120 to release one or more models from the memory of the UE 120 based on, for example, an amount of memory available at the UE 120. In some aspects, reference number 610 may occur at the second network node 110-2 rather than the first network node 110-1.

As shown by reference number 615, the first network node 110-1 may transmit, and the UE 120 may receive, a model release instruction. The model release instruction may be transmitted by the first network node 110-1 via RRC signaling. The model release instruction may instruct the UE 120 to release one or more models stored in the memory of the UE 120.

As shown by reference number 620, the first network node 110-1 may transmit, and the UE 120 may receive, a model transfer via RRC signaling. The model transfer may include one or more AI/ML models to be used by the UE 120.

As shown by reference number 625, the first network node 110-1 may update a UE AI/ML context. The UE AI/ML context may be updated to identify the models available to the UE 120 after the model release shown by reference number 615 and the model transfer shown by reference number 620.

As shown by reference number 630, the first network node 110-1 may initiate a handover of the UE 120 to the second network node 110-2.

As shown by reference number 635, the first network node 110-1 may transmit, and the second network node 110-2 may receive, a handover request. In some aspects, the handover request may include the UE AI/ML context. Accordingly, with the handover request, the second network node 110-2 may know which models are available to the UE 120.

As shown by reference number 640, the second network node 110-2 may transmit, and the first network node 110-1 may receive, a handover response. The handover response may include or identify one or more models not available at the UE 120.

As shown by reference number 645, the first network node 110-1 may transmit, and the UE 120 may receive, an RRC reconfiguration signal. The RRC reconfiguration signal may include the configuration for the UE 120 to begin communication on the target NG-RAN via the second network node 110-2.

As shown by reference number 650, the first network node 110-1 or the second network node 110-2 may transmit, and the UE 120 may receive, a model transfer via RRC signaling. The model transfer may include one or more AI/ML models for the UE 120 to apply when communicating via the target NG-RAN via the second network node 110-2. In some aspects, the model transfer occurs only if the UE 120 does not have one or more AI/ML models available.

As indicated above, FIG. 6 is provided as an example. Other examples may differ from what is described with respect to FIG. 6.

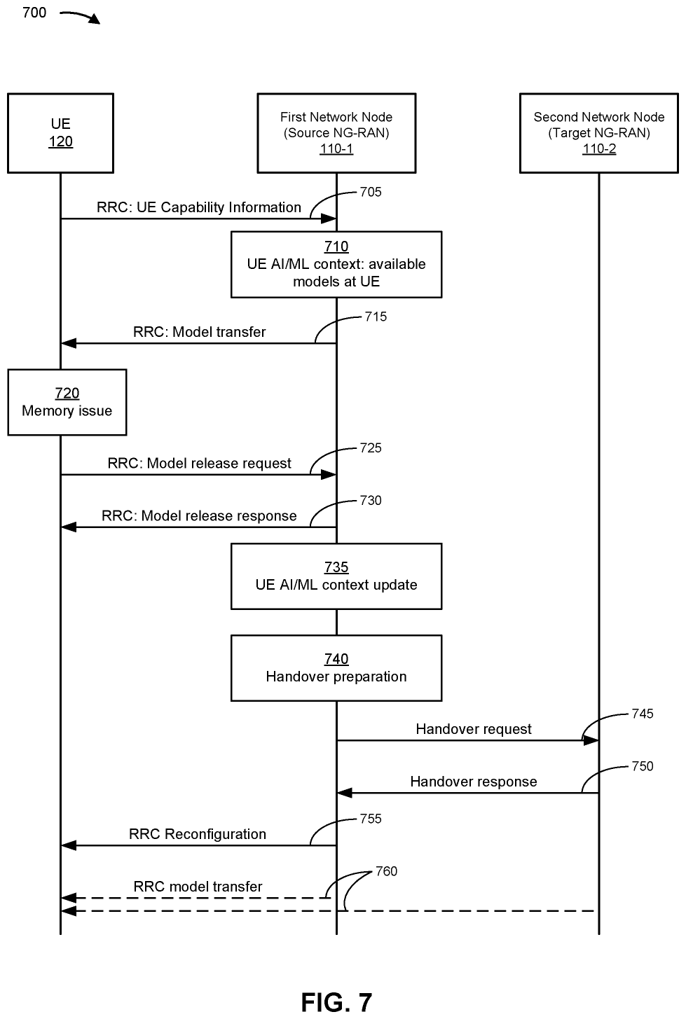

FIG. 7 is a diagram illustrating an example 700 associated with AI/ML model delivery via RRC signaling, in accordance with the present disclosure. As shown in FIG. 7, a first network node 110-1, a second network node 110-2, and a UE 120 may communicate with one another. The first network node 110-1 may be part of a source NG-RAN in communication with the UE 120 prior to a handover execution. The second network node 110-2 may be part of a target NG-RAN in communication with the UE 120 after a handover procedure. The handover procedure may include a handover of the UE 120 from the source NG-RAN to the target NG-RAN.

As shown by reference number 705, the UE 120 may transmit, and the first network node 110-1 may receive, UE capability information via RRC signaling. The UE capability information may indicate which models are supported by and available to the UE 120.

As shown by reference number 710, the first network node 110-1 may update a UE AI/ML context. The UE AI/ML context may be updated to identify the models supported by and/or available to the UE 120 in accordance with the UE capability information.

As shown by reference number 715, the first network node 110-1 may transmit, and the UE 120 may receive, the model transfer via RRC signaling. The model transfer may include one or more AI/ML models to be used by the UE 120.

As shown by reference number 720, the UE 120 may experience a memory issue. As a result, the UE 120 may determine that releasing one or more models may resolve the memory issue.

As shown by reference number 725, the UE 120 may transmit, and the first network node 110-1 may receive, a model release request. The model release request may be transmitted via RRC (e.g., via UE assistance information (UAI)) and may request permission, from the first network node 110-1, to release one or more AI/ML models from the memory of the UE 120.

As shown by reference number 730, the first network node 110-1 may transmit, and the UE 120 may receive, a model release response. The model release response may configure or otherwise instruct the UE 120 to release one or more of the models from the memory of the UE 120. In some aspects, the model release response indicates which of the models stored in the memory of the UE 120 can be released.

As shown by reference number 735, the first network node 110-1 may update the UE AI/ML context. The UE AI/ML context may be updated to remove or otherwise exclude the models released by the UE 120 after the model release response shown by reference number 730.

As shown by reference number 740, the first network node 110-1 may initiate a handover of the UE 120 to the second network node 110-2.

As shown by reference number 745, the first network node 110-1 may transmit, and the second network node 110-2 may receive, a handover request. In some aspects, the handover request may include the UE AI/ML context. Accordingly, with the handover request, the second network node 110-2 may know which models are available to the UE 120.

As shown by reference number 750, the second network node 110-2 may transmit, and the first network node 110-1 may receive, a handover response. The handover response may include or identify one or more models not available at the UE 120.

As shown by reference number 755, the first network node 110-1 may transmit, and the UE 120 may receive, an RRC reconfiguration signal. The RRC reconfiguration signal may include the configuration for the UE 120 to begin communication on the target NG-RAN via the second network node 110-2.

As shown by reference number 760, the first network node 110-1 or the second network node 110-2 may transmit, and the UE 120 may receive, a model transfer via RRC signaling. The model transfer may include one or more AI/ML models for the UE 120 to apply when communicating via the target NG-RAN via the second network node 110-2. In some aspects, the model transfer occurs only if the UE 120 does not have one or more AI/ML models available.

As indicated above, FIG. 7 is provided as an example. Other examples may differ from what is described with respect to FIG. 7.

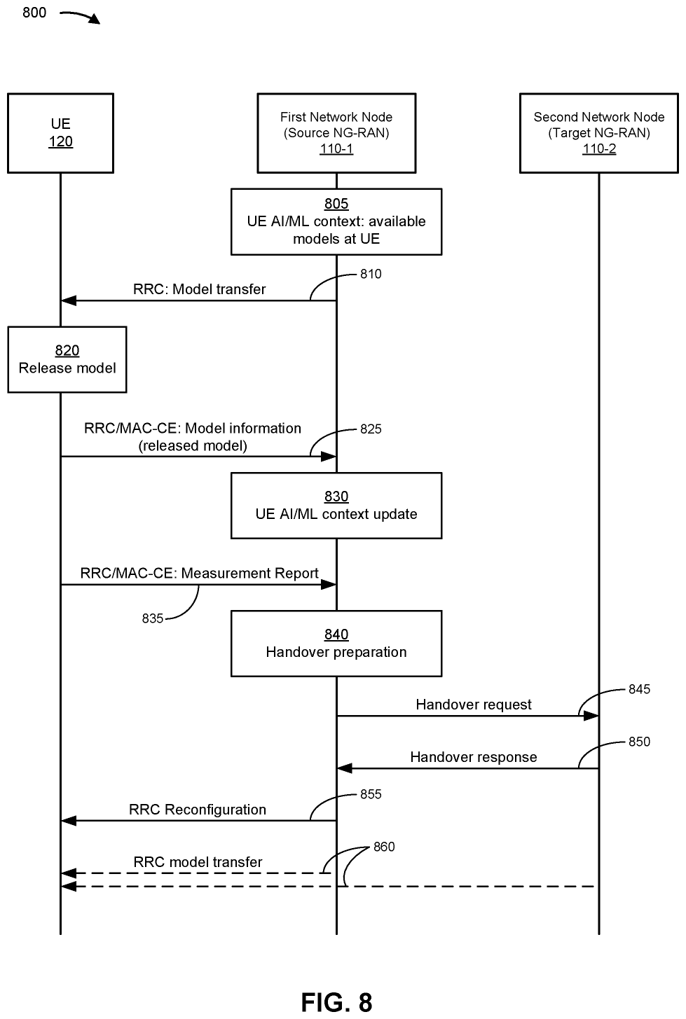

FIG. 8 is a diagram illustrating an example 800 associated with AI/ML model delivery via RRC signaling, in accordance with the present disclosure. As shown in FIG. 8, a first network node 110-1, a second network node 110-2, and a UE 120 may communicate with one another. The first network node 110-1 may be part of a source NG-RAN in communication with the UE 120 prior to a handover execution. The second network node 110-2 may be part of a target NG-RAN in communication with the UE 120 after a handover procedure. The handover procedure may include a handover of the UE 120 from the source NG-RAN to the target NG-RAN.

As shown by reference number 805, the first network node 110-1 may update a UE AI/ML context. The UE AI/ML context may be updated to identify the models supported by and/or available to the UE 120 in accordance with the UE capability information.

As shown by reference number 810, the first network node 110-1 may transmit, and the UE 120 may receive, the model transfer via RRC signaling. The model transfer may include one or more AI/ML models to be used by the UE 120.

As shown by reference number 820, the UE 120 may release one or more models. In some aspects, the UE 120 may release the one or more models without a model release instruction from the first network node 110-1.

As shown by reference number 825, the UE 120 may transmit, and the first network node 110-1 may receive, model information. In some aspects, the model information may indicate the one or more models available or released. In some aspects, the model information may indicate the models still available to the UE 120 after the one or more models were released. In some aspects, the model information is transmitted from the UE to the first network node 110-1 via RRC signaling, MAC control element (MAC-CE) signaling, and/or a combination thereof, among other examples.

As shown by reference number 830, the first network node 110-1 may update the UE AI/ML context. The UE AI/ML context may be updated to remove or otherwise exclude the models released by the UE 120 after the model release shown by reference number 820.

As shown by reference number 835, the UE 120 may transmit, and the first network node 110-1 may receive, a measurement report. The UE 120 may transmit the measurement report via RRC signaling, MAC-CE signaling, and/or a combination thereof, among other examples.

As shown by reference number 840, the first network node 110-1 may initiate a handover of the UE 120 to the second network node 110-2.

As shown by reference number 845, the first network node 110-1 may transmit, and the second network node 110-2 may receive, a handover request. In some aspects, the handover request may include the UE AI/ML context. Accordingly, with the handover request, the second network node 110-2 may know which models are available to the UE 120.

As shown by reference number 850, the second network node 110-2 may transmit, and the first network node 110-1 may receive, a handover response. The handover response may include or identify one or more models not available at the UE 120.

As shown by reference number 855, the first network node 110-1 may transmit, and the UE 120 may receive, an RRC reconfiguration signal. The RRC reconfiguration signal may include the configuration for the UE 120 to begin communication on the target NG-RAN via the second network node 110-2.

As shown by reference number 860, the first network node 110-1 or the second network node 110-2 may transmit, and the UE 120 may receive, a model transfer via RRC signaling. The model transfer may include one or more AI/ML models for the UE 120 to apply when communicating via the target NG-RAN via the second network node 110-2. In some aspects, the model transfer occurs only if the UE 120 does not have one or more AI/ML models available.

As indicated above, FIG. 8 is provided as an example. Other examples may differ from what is described with respect to FIG. 8.

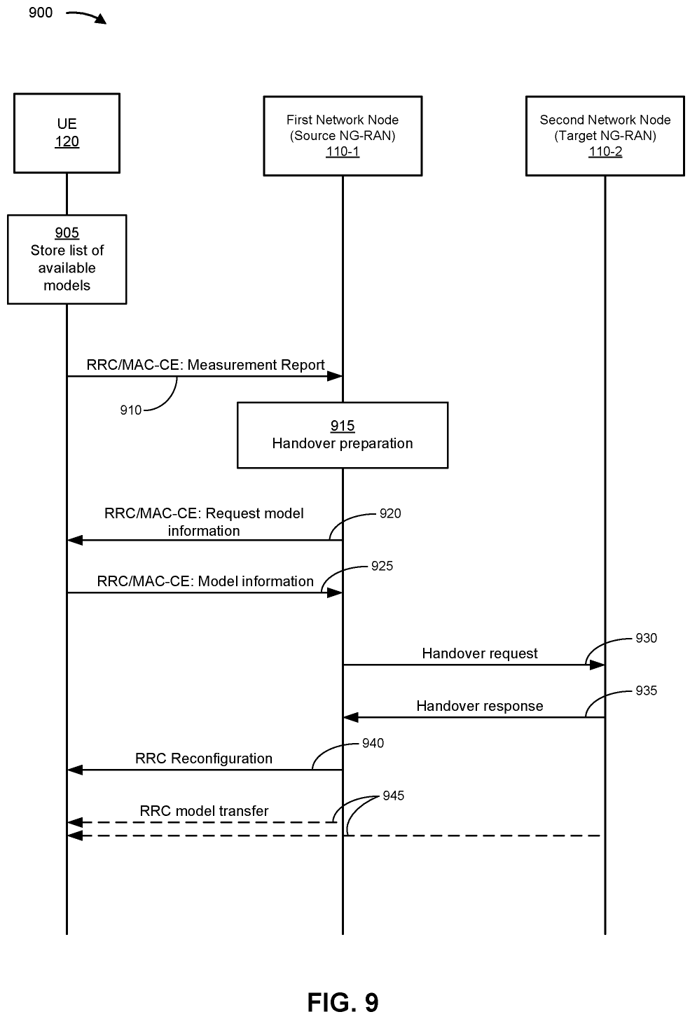

FIG. 9 is a diagram illustrating an example 900 associated with AI/ML model delivery via RRC signaling, in accordance with the present disclosure. As shown in FIG. 9, a first network node 110-1, a second network node 110-2, and a UE 120 may communicate with one another. The first network node 110-1 may be part of a source NG-RAN in communication with the UE 120 prior to a handover execution. The second network node 110-2 may be part of a target NG-RAN in communication with the UE 120 after a handover procedure. The handover procedure may include a handover of the UE 120 from the source NG-RAN to the target NG-RAN.

As shown by reference number 905, the UE 120 may store a list of available models. In some aspects, the list of available models may be stored in an RRC variable.

As shown by reference number 910, the UE 120 may transmit, and the first network node 110-1 may receive, a measurement report. The UE 120 may transmit the measurement report via RRC signaling, MAC-CE signaling, and/or a combination thereof, among other examples.

As shown by reference number 915, the first network node 110-1 may initiate a handover of the UE 120 to the second network node 110-2.

As shown by reference number 920, the first network node 110-1 may transmit, and the UE 120 may receive, a request for model information. The request for model information may be transmitted via RRC signaling, MAC-CE signaling, and/or a combination thereof, among other examples. In some aspects, the model information includes a model identifier for each model available to the UE 120.

As shown by reference number 925, the UE 120 may transmit, and the first network node 110-1 may receive, the model information. The model information may be transmitted to the first network node 110-1 via RRC signaling, MAC-CE signaling, and/or a combination thereof, among other examples.

As shown by reference number 930, the first network node 110-1 may transmit, and the second network node 110-2 may receive, a handover request. In some aspects, the handover request may include the UE AI/ML context. Accordingly, with the handover request, the second network node 110-2 may know which models are available to the UE 120.

As shown by reference number 935, the second network node 110-2 may transmit, and the first network node 110-1 may receive, a handover response. The handover response may include or identify one or more models not available at the UE 120.

As shown by reference number 940, the first network node 110-1 may transmit, and the UE 120 may receive, an RRC reconfiguration signal. The RRC reconfiguration signal may include the configuration for the UE 120 to begin communication on the target NG-RAN via the second network node 110-2.

As shown by reference number 945, the first network node 110-1 or the second network node 110-2 may transmit, and the UE 120 may receive, a model transfer via RRC signaling. The model transfer may include one or more AI/ML models for the UE 120 to apply when communicating via the target NG-RAN via the second network node 110-2. In some aspects, the model transfer occurs only if the UE 120 does not have one or more AI/ML models available.

As indicated above, FIG. 9 is provided as an example. Other examples may differ from what is described with respect to FIG. 9.

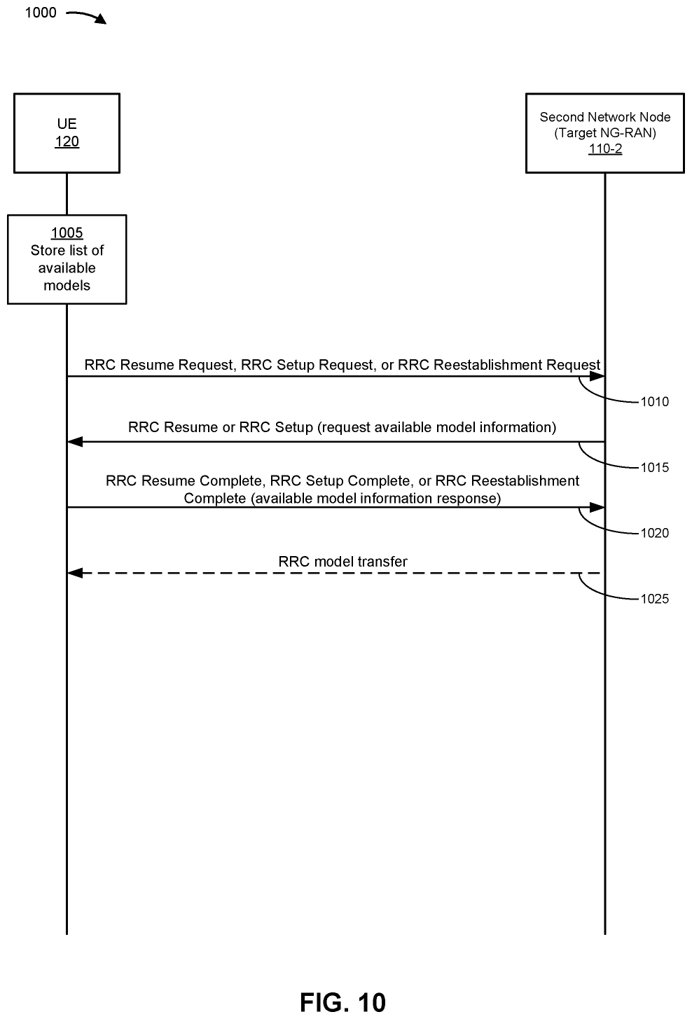

FIG. 10 is a diagram illustrating an example 1000 associated with AI/ML model delivery via RRC signaling, in accordance with the present disclosure. As shown in FIG. 10, a second network node 110-2 and a UE 120 may communicate with one another. The second network node 110-2 may be part of a target NG-RAN in communication with the UE 120 as a result of, e.g., the UE 120 returning to an active state from an idle/inactive state.

As shown by reference number 1005, the UE 120 may store a list of available models. In some aspects, the list of available models is stored in an RRC variable.

As shown by reference number 1010, the UE 120 may transmit, and the second network node 110-2 may receive, an RRC resume request, an RRC setup request, or an RRC reestablishment request. The RRC resume request, the RRC setup request, or the RRC reestablishment request may indicate, to the second network node 110-2, a transition of the UE 120 from an idle/inactive state to an active state.

As shown by reference number 1015, the second network node 110-2 may transmit, and the UE 120 may receive, an RRC resume or an RRC setup signal. The RRC resume or the RRC setup signal may include a request for the available model information stored by the UE 120.

As shown by reference number 1020, the UE 120 may transmit, and the second network node 110-2 may receive, an RRC resume complete, an RRC setup complete, or an RRC reestablishment complete signal. The RRC resume complete, the RRC setup complete, or the RRC reestablishment complete signal may include the response to the request, by the second network node 110-2, for the model information stored by the UE 120.

As shown by reference number 1025, the second network node 110-2 may transmit, and the UE 120 may receive, a model transfer via RRC signaling. The model transfer may include one or more AI/ML models for the UE 120 to apply when communicating via the target NG-RAN via the second network node 110-2. In some aspects, the model transfer occurs only if the UE 120 does not have one or more AI/ML models available.

As indicated above, FIG. 10 is provided as an example. Other examples may differ from what is described with respect to FIG. 10.

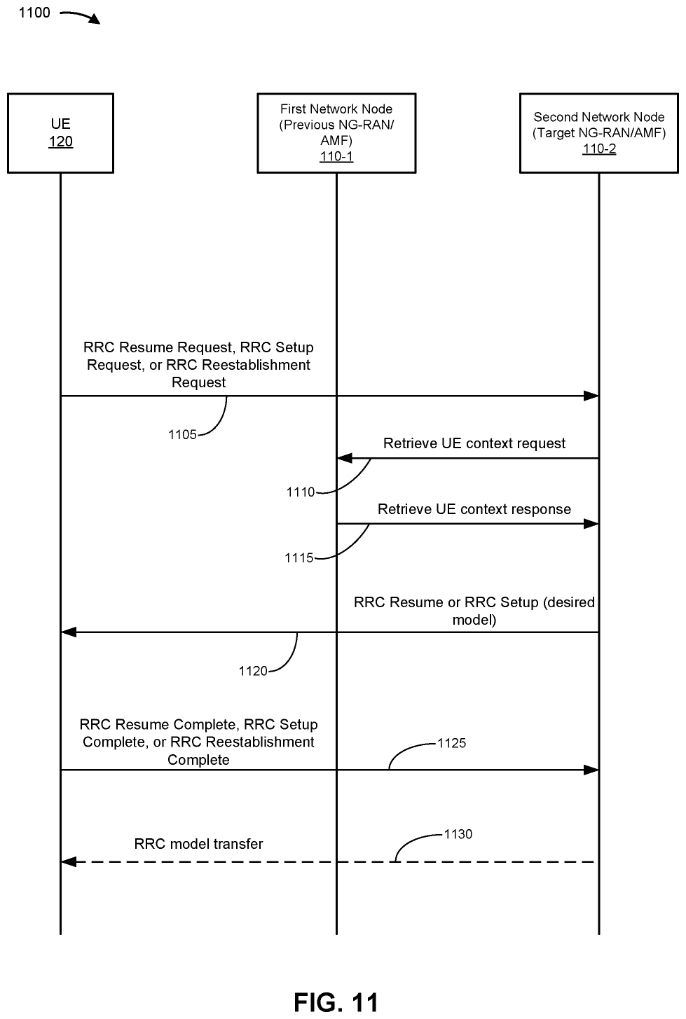

FIG. 11 is a diagram illustrating an example 1100 associated with AI/ML model delivery via RRC signaling, in accordance with the present disclosure. As shown in FIG. 11, a first network node 110-1, a second network node 110-2, and a UE 120 may communicate with one another. The first network node 110-1 may be part of a previous NG-RAN in communication with the UE 120 prior to the UE 120 entering the idle/inactive state. In some aspects, the first network node 110-1 is an access and mobility function (AMF). The second network node 110-2 may be part of a target NG-RAN in communication with the UE 120 as a result of, e.g., the UE 120 returning to an active state from an idle/inactive state.

As shown by reference number 1105, the UE 120 may transmit, and the second network node 110-2 may receive, an RRC resume request, an RRC setup request, or an RRC reestablishment request. The RRC resume request, the RRC setup request, or the RRC reestablishment request may indicate, to the second network node 110-2, a transition of the UE 120 from an idle/inactive state to an active state.

As shown by reference number 1110, the second network node 110-2 may transmit, and the first network node 110-1 may receive, a retrieve UE context request. The retrieve UE context request may include a request for the first network node 110-1 to retrieve a list or other identification of AI/ML models available to the UE 120.

As shown by reference number 1115, the first network node 110-1 may transmit, and the second network node 110-2 may receive, a retrieve UE context request response. The retrieve UE context request response may include the list or other identification of the AI/ML models available to the UE 120.

As shown by reference number 1120, the second network node 110-2 may transmit, and the UE 120 may receive, an RRC resume or an RRC setup signal. The RRC resume or the RRC setup signal may transfer one or more AI/ML models to the UE 120 from the second network node 110-2.

As shown by reference number 1125, the UE 120 may transmit, and the second network node 110-2 may receive, an RRC resume complete, an RRC setup complete, or an RRC reestablishment complete signal. The RRC resume complete, the RRC setup complete, or the RRC reestablishment complete signal may indicate, to the second network node 110-2, that the UE 120 received the AI/ML model transfer.

As shown by reference number 1130, the second network node 110-2 may transmit, and the UE 120 may receive, an additional model transfer via RRC signaling. The additional model transfer may include one or more AI/ML models for the UE 120 to apply when communicating via the target NG-RAN via the second network node 110-2. In some aspects, the additional model transfer occurs only if the UE 120 does not have one or more AI/ML models available. For example, the additional model transfer may occur if more AI/ML models are needed or if the model transfer shown by reference number 1130 was incomplete, among other examples.

As indicated above, FIG. 11 is provided as an example. Other examples may differ from what is described with respect to FIG. 11.

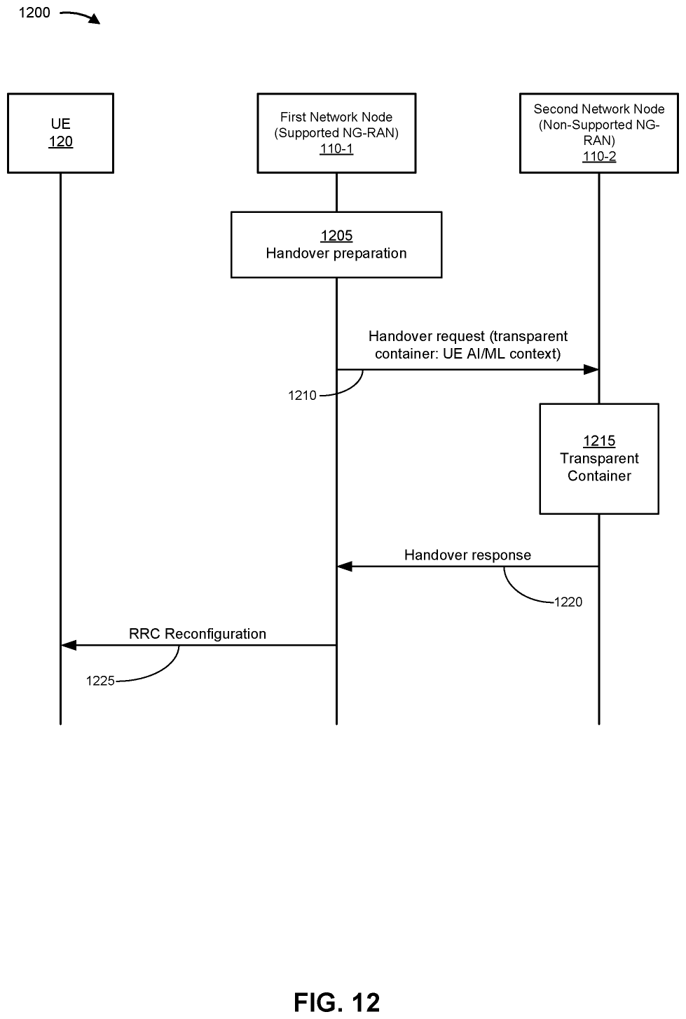

FIG. 12 is a diagram illustrating an example 1200 associated with AI/ML model delivery via RRC signaling, in accordance with the present disclosure. As shown in FIG. 12, a first network node 110-1, a second network node 110-2, and a UE 120 may communicate with one another. The first network node 110-1 may be part of a supported NG-RAN in communication with the UE 120 prior to a handover execution. The second network node 110-2 may be part of a non-supported NG-RAN (e.g., an NG-RAN that does not support one or more AI/ML models used by the UE 120) in communication with the UE 120 after a handover procedure. The handover procedure may include a handover of the UE 120 during mobility from the supported NG-RAN to the non-supported NG-RAN.

As shown by reference number 1205, the first network node 110-1 may initiate a handover of the UE 120 to the second network node 110-2.

As shown by reference number 1210, the first network node 110-1 may transmit, and the second network node 110-2 may receive, a handover request. In some aspects, the handover request may include a transparent container with the UE AI/ML context. Accordingly, with the handover request, the second network node 110-2 may know which models are available to the UE 120.

As shown by reference number 1215, the second network node 110-2 may store the transparent container containing the UE AI/ML context. In some aspects, the second network node 110-2 may update the transparent container to include one or more AI/ML models.

As shown by reference number 1220, the second network node 110-2 may transmit, and the first network node 110-1 may receive, a handover response. The handover response may include the transparent container with one or more AI/ML models for use by the UE 120.

As shown by reference number 1225, the first network node 110-1 may transmit, and the UE 120 may receive, an RRC reconfiguration signal. The RRC reconfiguration signal may include the configuration for the UE 120 to begin communication on the non-supported NG-RAN via the second network node 110-2. In some aspects, the RRC reconfiguration signal may include the transparent container.

As indicated above, FIG. 12 is provided as an example. Other examples may differ from what is described with respect to FIG. 12.

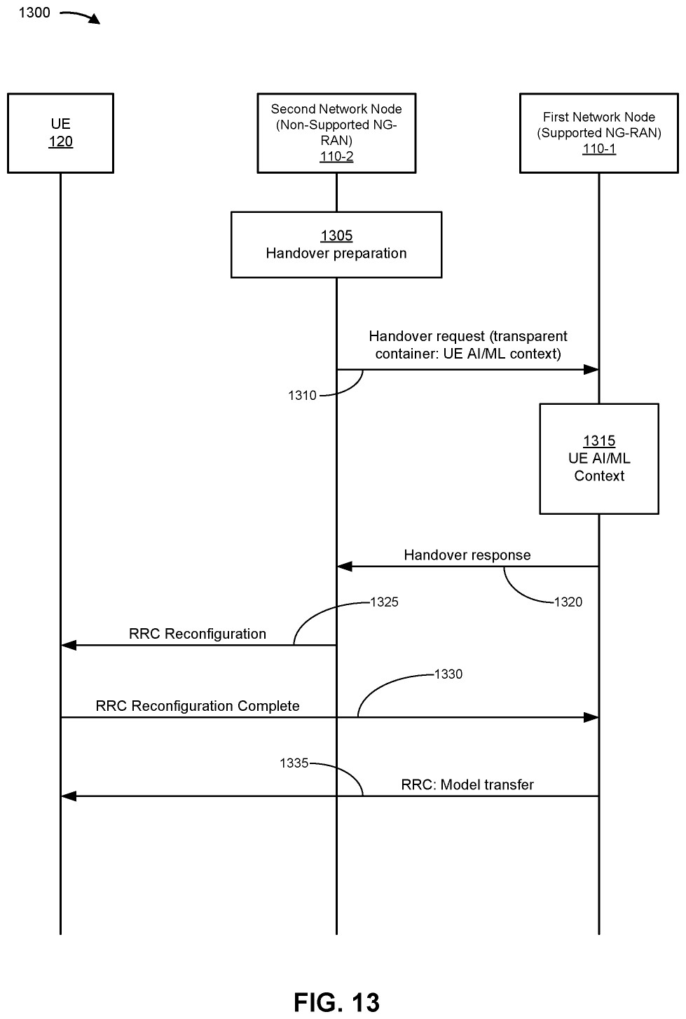

FIG. 13 is a diagram illustrating an example 1300 associated with AI/ML model delivery via RRC signaling, in accordance with the present disclosure. As shown in FIG. 13, a first network node 110-1, a second network node 110-2, and a UE 120 may communicate with one another. The first network node 110-1 may be part of a supported NG-RAN in communication with the UE 120 after a handover execution. The second network node 110-2 may be part of a non-supported NG-RAN in communication with the UE 120 prior to a handover procedure. The handover procedure may include a handover of the UE 120 during mobility from the non-supported NG-RAN to the supported NG-RAN.

As shown by reference number 1305, the second network node 110-2 may initiate a handover of the UE 120 to the first network node 110-1.

As shown by reference number 1310, the second network node 110-2 may transmit, and the first network node 110-1 may receive, a handover request. In some aspects, the handover request may include a transparent container with the UE AI/ML context. The UE AI/ML context, as discussed above, may include available model information communicated to the second network node 110-2 by UE 120. Accordingly, with the handover request, the first network node 110-1 may know which models are available to the UE 120.

As shown by reference number 1315, the first network node 110-1 may store the UE AI/ML context.

As shown by reference number 1320, the first network node 110-1 may transmit, and the second network node 110-2 may receive, a handover response. The handover response may include the UE AI/ML context in a transparent container.

As shown by reference number 1325, the second network node 110-2 may transmit, and the UE 120 may receive, an RRC reconfiguration signal. The RRC reconfiguration signal may include the configuration for the UE 120 to begin communication on the supported NG-RAN via the first network node 110-1. In some aspects, the RRC reconfiguration signal may include one or more AI/ML models.

As shown by reference number 1330, the UE 120 may transmit, and the first network node 110-1 may receive, an RRC Reconfiguration Complete signal. The RRC Reconfiguration Complete signal may indicate that the UE 120 is configured to communicate on the supported NG-RAN via the first network node 110-1.

As shown by reference number 1335, the first network node 110-1 may transmit, and the UE 120 may receive, one or more additional AI/ML models.

As indicated above, FIG. 13 is provided as an example. Other examples may differ from what is described with respect to FIG. 13.

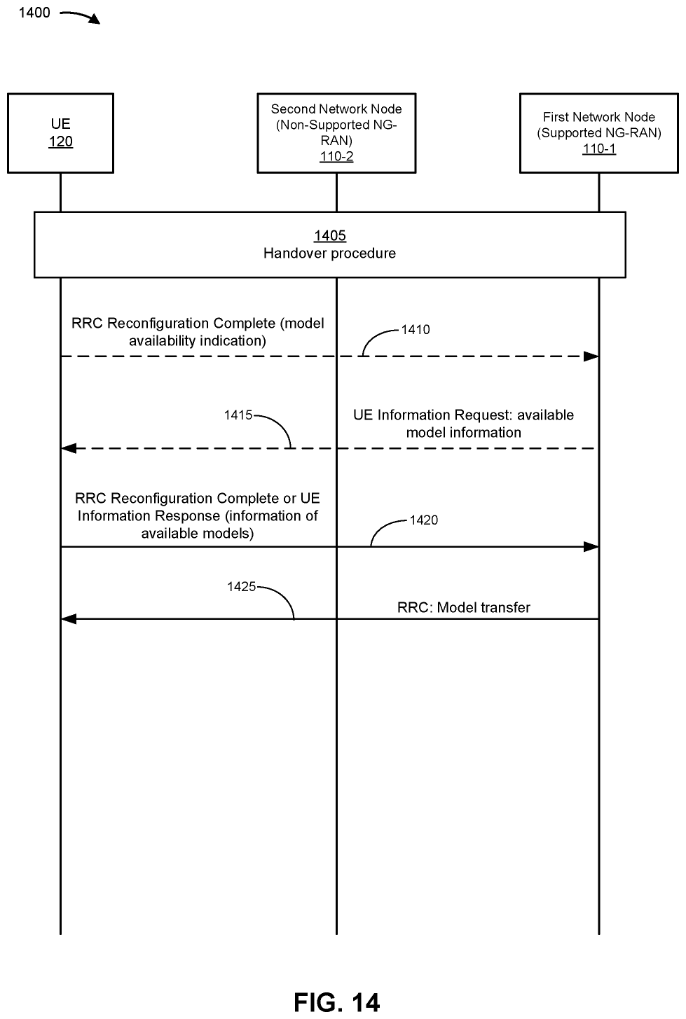

FIG. 14 is a diagram illustrating an example 1400 associated with AI/ML model delivery via RRC signaling, in accordance with the present disclosure. As shown in FIG. 14, a first network node 110-1, a second network node 110-2, and a UE 120 may communicate with one another. The first network node 110-1 may be part of a supported NG-RAN in communication with the UE 120 after a handover execution (e.g., completion of a handover procedure). The second network node 110-2 may be part of a non-supported NG-RAN in communication with the UE 120 prior to a handover execution. The handover procedure may include a handover of the UE 120 during mobility from the non-supported NG-RAN to the supported NG-RAN.

As shown by reference number 1405, the first network node 110-1, the second network node 110-2, and the UE 120 may participate in a handover procedure to, for example, transition the UE 120 to communicating over the supported NG-RAN via the first network node 110-1 from the non-supported NG-RAN via the second network node 110-2. The handover procedure may include the first network node 110-1 or the second network node 110-2 transmitting, and the UE 120 receiving, an RRC reconfiguration signal with a configuration for the UE 120 to begin communication on the non-supported NG-RAN via the second network node 110-2. In some aspects, the RRC reconfiguration signal may include one or more AI/ML models.

As shown by reference number 1410, the UE 120 may transmit, and the first network node 110-1 may receive, an RRC reconfiguration complete signal. The RRC reconfiguration complete signal may indicate that the UE 120 is configured to communicate on the supported NG-RAN via the first network node 110-1. In some aspects, the RRC reconfiguration complete signal may indicate one or more AI/ML models available to the UE 120.

Alternatively or in addition, as shown by reference number 1415, the first network node 110-1 may transmit, and the UE 120 may receive, a UE information request. The UE information request may request, from the UE 120, an identification of one or more AI/ML models available to the UE 120.

As shown by reference number 1420, the UE 120 may transmit, and the first network node 110-1 may receive, an RRC reconfiguration complete signal or UE information response signal. The RRC reconfiguration complete signal or the UE information response signal shown by reference number 1420 may include information about one or more AI/ML models available to the UE 120.

As shown by reference number 1425, the first network node 110-1 may transmit, and the UE 120 may receive, a model transfer via RRC signaling. The model transfer may include one or more AI/ML models. In some aspects, one or more of the AI/ML models included in the model transfer may differ from one or more of the AI/ML models indicated in the RRC Reconfiguration Complete signal or the UE Information Response signal.

As indicated above, FIG. 14 is provided as an example. Other examples may differ from what is described with respect to FIG. 14.

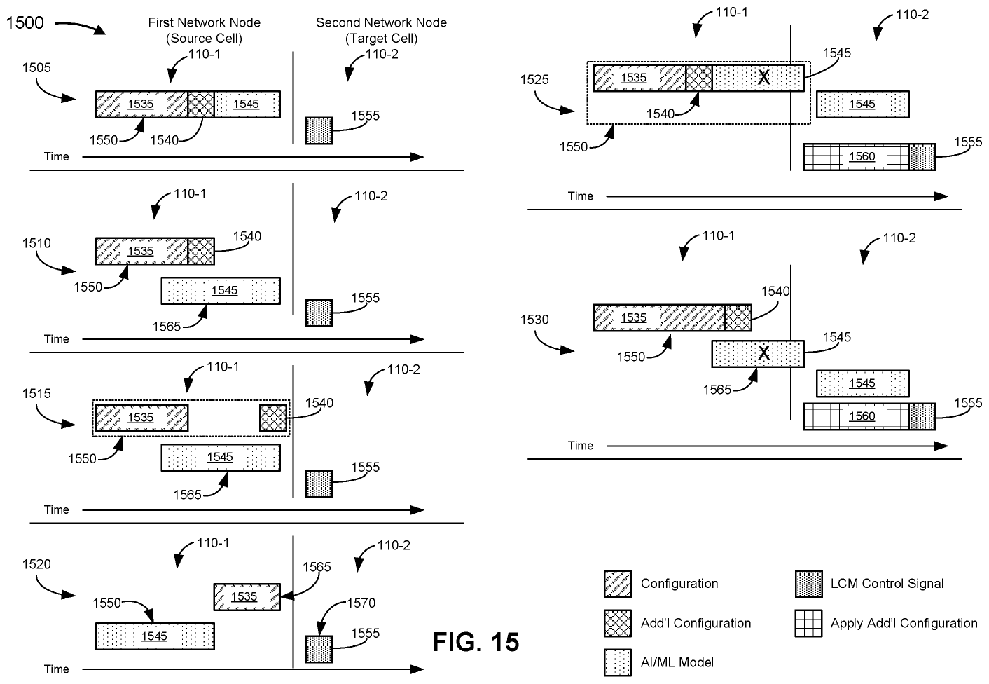

FIG. 15 is a diagram illustrating examples 1500 associated with configuration and model delivery, in accordance with the present disclosure. As shown in FIG. 15, example 1500 includes communications between a first network node 110-1 and a UE (not shown) and between a second network node 110-2 and the UE. In some examples, such UE may be the UE 120 described herein. In some aspects, the first network node 110-1 is part of a source NG-RAN (e.g., a source cell as shown in FIG. 15) and the second network node 110-2 is part of a target NG-RAN (e.g., a target cell as shown in FIG. 15).

As shown by reference number 1505, in one example, the first network node 110-1 may provide to a UE a configuration 1535, an additional configuration 1540 (sometimes referred to as a fallback configuration), and the AI/ML model 1545 via the same signaling radio bearer (SRB) 1550. Upon successful delivery of the AI/ML model 1545 model to the UE, the first network node 110-1 may transmit an indication to the second network node. Alternatively, the UE may indicate, to the second network node 110-2, that the UE has received all configured AI/ML models and/or a list of received or available AI/ML models. In some aspects, the second network node 110-2 may transmit an LCM control signal 1555 to the UE following the handover from the first network node 110-1 to the second network node 110-2. The LCM control signal 1555 may include a control signal used to manage the lifecycle of one or more network functions or services such as the creation, modification, and termination of network functions. In some aspects, such as during a handover procedure, the LCM control signal 1555 may be used to allocate resources that facilitate the handover to the target cell without degrading service quality.

As shown by reference number 1510, in one example, the first network node 110-1 may provide to a UE a configuration 1535 and an additional configuration 1540 in a first SRB 1550, and may provide to the UE the AI/ML model 1545 via a second SRB 1565. In the example shown by reference 1510, the first SRB 1550 may have a higher priority than the second SRB 1565. Upon successful delivery of the model 1545, the first network node 110-1 may transmit an indication to the second network node 110-2. Alternatively, the UE may indicate, to the second network node 110-2, that the UE has received all configured AI/ML models and/or a list of received or available AI/ML models. In some aspects, the second network node 110-2 may transmit an LCM control signal 1555 to the UE following the handover from the first network node 110-1 to the second network node 110-2.

As shown by reference number 1515, in one example, the first network node 110-1 may provide to a UE a configuration 1535 and an additional configuration 1540 in a first SRB 1550, and may provide to the UE the AI/ML model 1545 via a second SRB 1565. In the example shown by reference 1515, the first SRB 1550 may have a higher priority than the second SRB 1565. If the first network node 110-1 determines that the AI/ML models cannot be transmitted within a predetermined time, the first network node 110-1 may transmit a partial configuration 1535 and/or a partial additional configuration 1540 before transmitting the AI/ML model 1545. After transmitting the partial configuration 1535 or additional configuration 1540, the first network node 110-1 may transmit a remainder of the configuration 1535 or additional configuration 1540. Upon successful delivery of the model 1545, the first network node 110-1 may transmit an indication to the second network node 110-2. Alternatively, the UE may indicate, to the second network node 110-2, that the UE has received all configured AI/ML models and/or a list of received or available AI/ML models. In some aspects, the second network node 110-2 may transmit an LCM control signal 1555 to the UE following the handover from the first network node 110-1 to the second network node 110-2.

As shown by reference number 1520, in one example, the first network node 110-1 may provide to a UE a configuration 1535, and the AI/ML model 1545 via the same or different SRBs as the handover configuration and model delivery. For example, as shown in FIG. 15, the configuration 1535 may be transmitted in the second SRB 1565, the AI/ML model 1545 may be transmitted in the first SRB 1545, and the LCM control signal 1555 may be transmitted in a third SRB 1570. Alternatively, similar to the example shown by reference number 1515, the configuration 1535 and an additional configuration 1540 may be transmitted in the first SRB 1550 and the AI/ML model 1545 may be transmitted in the second SRB 1565. In another alternative (discussed below with respect to reference number 1525), the configuration 1535, the additional configuration 1540, and the AI/ML model 1545 may be transmitted in a single SRB (e.g., the first SRB 1550). The first network node 110-1 may transmit the AI/ML model 1545 and the handover configuration after the model delivery is complete. Upon successful delivery of the AI/ML model 1545, the first network node 110-1 may transmit an indication to the second network node 110-2. Alternatively, the UE may indicate, to the second network node 110-2, that the UE has received all configured AI/ML models and/or a list of received or available AI/ML models. In some aspects, the second network node 110-2 may transmit an LCM control signal 1555 to the UE following the handover from the first network node 110-1 to the second network node 110-2.

As shown by reference number 1525, in one example, the first network node 110-1 may begin to provide to a UE a configuration 1535, an additional configuration 1540, and the AI/ML model 1545 via the same SRB (e.g., the first SRB 1550). In instances where the first network node 110-1 is unable to complete the model transfer, the first network node 110-1 may send an indication to the second network node 110-2 that delivery of the AI/ML model 1545 to the UE failed, and the UE may apply the additional configuration 1560 while the second network node 110-2 transmits the AI/ML model 1545 to the UE. Upon successful delivery of the AI/ML model 1545, the UE may indicate, to the second network node 110-2, that the UE has received all configured AI/ML models and/or a list of received or available AI/ML models. In some aspects, the UE may indicate, to the second network node 110-2, that additional AI/ML models need to be transferred. In some aspects, the indications to the second network node 110-2 from the UE are made via RRC signaling. In some aspects, the second network node 110-2 may transmit an LCM control signal 1555 to the UE following the handover from the first network node 110-1 to the second network node 110-2.

As shown by reference number 1530, in one example, the first network node 110-1 may begin to provide to a UE a configuration 1535 and an additional configuration 1540 via a first SRB 1550, and may begin to provide to the UE the AI/ML model 1545 via a second SRB 1565. In instances where the first network node 110-1 is unable to complete transfer of the AI/ML model 1545 to the UE, the first network node 110-1 may send an indication to the second network node 110-2 that the delivery of the AI/ML model 1545 to the UE failed, and the UE may apply the additional configuration while the second network node 110-2 transmits the AI/ML model 1545 to the UE.

Upon successful delivery of the AI/ML model 1545, the UE may indicate, to the second network node 110-2, that the UE has received all configured AI/ML models and/or a list of received or available AI/ML models. In some aspects, the UE may indicate, to the second network node 110-2, that additional AI/ML models need to be transferred. In some aspects, the indications to the second network node 110-2 from the UE are made via RRC signaling. In some aspects, the second network node 110-2 may transmit an LCM control signal 1555 to the UE following the handover from the first network node 110-1 to the second network node 110-2.

With respect to the examples above, in some aspects, the AI/ML models may be treated as “activated” by default, in which case the second network node 110-2 may not need to send the LCM control signal 1555 for model activation. In some instances, such as in the case of model delivery failure, the second network node 110-2 may send a temporary configuration to the UE. In some instances, the temporary configuration may include low-complexity, lightweight reference models to be used until one or more of the desired AI/ML models are delivered to the UE. In some instances, such as when the model is successfully delivered before the configuration, a temporary configuration from the first network node 110-1 may not be needed. The first network node 110-1 may release the temporary configuration upon successful delivery of the AI/ML model.

As indicated above, FIG. 15 is provided as an example. Other examples may differ from what is described with respect to FIG. 15.

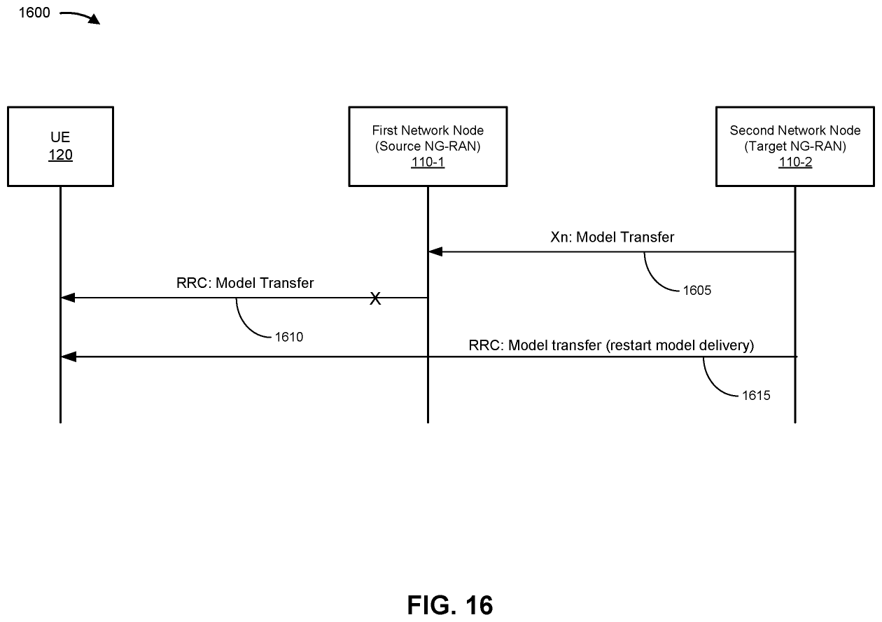

FIG. 16 is a diagram illustrating an example 1600 associated with AI/ML model delivery via RRC signaling, in accordance with the present disclosure. As shown in FIG. 16, a first network node 110-1, a second network node 110-2, and a UE 120 may communicate with one another. The first network node 110-1 may be part of a source NG-RAN in communication with the UE prior to a handover execution. The second network node 110-2 may be part of a target NG-RAN in communication with the UE after a handover procedure. The handover procedure may include a handover of the UE 120 from the source NG-RAN to the target NG-RAN. As shown by reference number 1605, the second network node 110-2 may transmit, and the first network node 110-1 may receive, a model transfer (e.g., a transfer of an AI/ML model). The model transfer may occur during an Xn-based handover procedure between the first network node 110-1 and the second network node 110-2. As shown by reference number 1610, the first network node 110-1 attempts to transmit the AI/ML model to the UE 120 via RRC signaling but the model transfer fails. In some aspects, as shown by reference number 1615, the second network node 110-2 may restart the model delivery (e.g., to achieve the model transfer) to the UE 120 via RRC signaling. As indicated above, FIG. 16 is provided as an example. Other examples may differ from what is described with respect to FIG. 16.

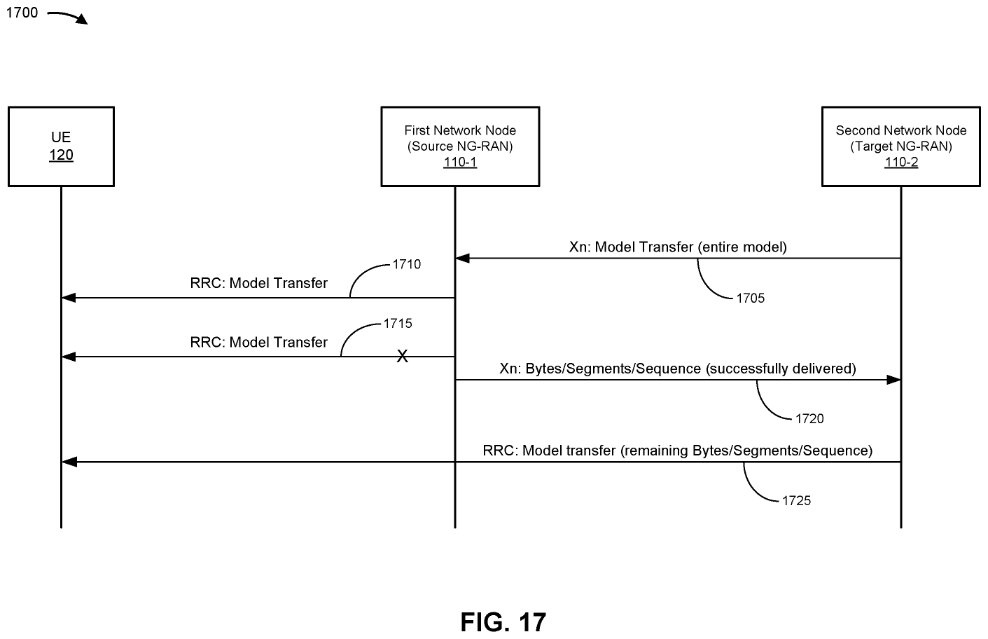

FIG. 17 is a diagram illustrating an example 1700 associated with AI/ML model delivery via RRC signaling, in accordance with the present disclosure. As shown in FIG. 17, a first network node 110-1, a second network node 110-2, and a UE 120 may communicate with one another. The first network node 110-1 may be part of a source NG-RAN in communication with the UE 120 prior to a handover execution. The second network node 110-2 may be part of a target NG-RAN in communication with the UE 120 after a handover procedure. The handover procedure may include a handover of the UE from the source NG-RAN to the target NG-RAN. As shown by reference number 1705, the second network node 110-2 may transmit, and the first network node 110-1 may receive, a model transfer (e.g., a transfer of an AI/ML model). The model transfer may occur during an Xn-based handover procedure between the first network node 110-1 and the second network node 110-2. As shown by reference number 1710, the first network node 110-1 transmits at least part of the AI/ML model to the UE 120 via RRC signaling. As shown by reference number 1715, at least part of the model transfer between the first network node 110-1 and UE 120 fails. As shown by reference number 1720, the first network node 110-1 may indicate, to the second network node 110-2, a byte, segment, or sequence number associated with the partial (e.g., incomplete) transmission of the AI/ML model. Accordingly, the indication shown by reference number 1720 may indicate, to the second network node 110-2, how much of the AI/ML model was received by the UE 120. As shown by reference number 1725, the second network node 110-2 may transmit the remaining bytes, segment, or sequence of the AI/ML model to the UE 120 via RRC signaling, resulting in a lossless model transfer during the Xn-based handover. As indicated above, FIG. 17 is provided as an example. Other examples may differ from what is described with respect to FIG. 17.

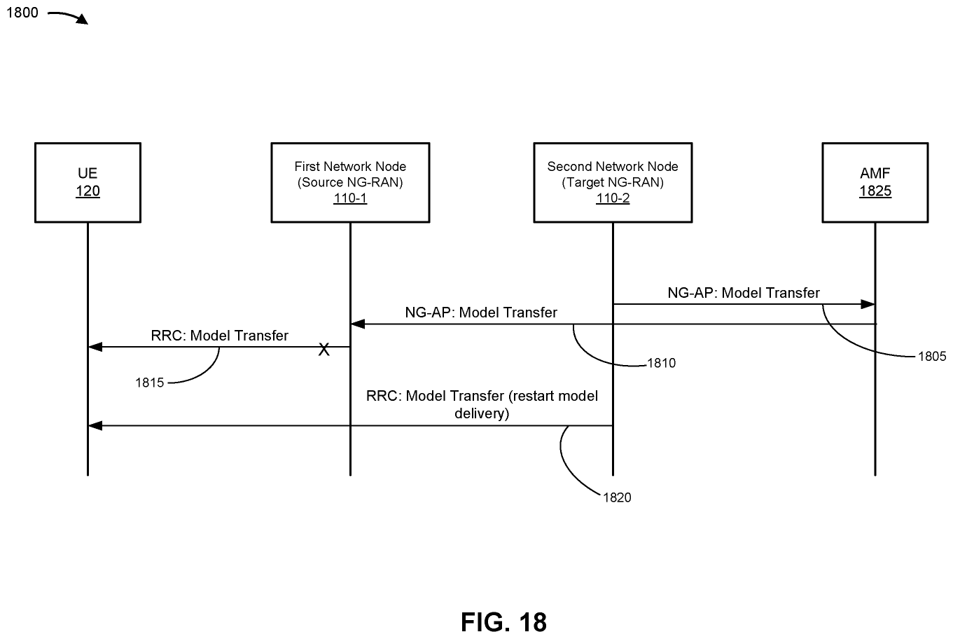

FIG. 18 is a diagram illustrating an example 1800 associated with AI/ML model delivery via RRC signaling, in accordance with the present disclosure. As shown in FIG. 18, a first network node 110-1, a second network node 110-2, and a UE 120 may communicate with one another. The first network node 110-1 may be part of a source NG-RAN in communication with the UE 120 prior to a handover execution. The second network node 110-2 may be part of a target NG-RAN in communication with the UE 120 after a handover procedure. The handover procedure may include a handover of the UE 120 from the source NG-RAN to the target NG-RAN. As shown by reference number 1805, the second network node 110-2 may transmit the AI/ML model to an AMF 1825 via an NG application protocol (AP). As shown by reference number 1810, the AMF 1825 may transmit, and the first network node 110-1 may receive, the model transfer (e.g., the transfer of the AI/ML model) via the NG-AP. As shown by reference number 1815, the first network node 110-1 attempts to transmit the AI/ML model to the UE 120 via RRC signaling but the model transfer fails. In some aspects, as shown by reference number 1820, the second network node 110-2 may restart the model delivery (e.g., to achieve the model transfer) to the UE 120 via RRC signaling. As indicated above, FIG. 18 is provided as an example. Other examples may differ from what is described with respect to FIG. 18.

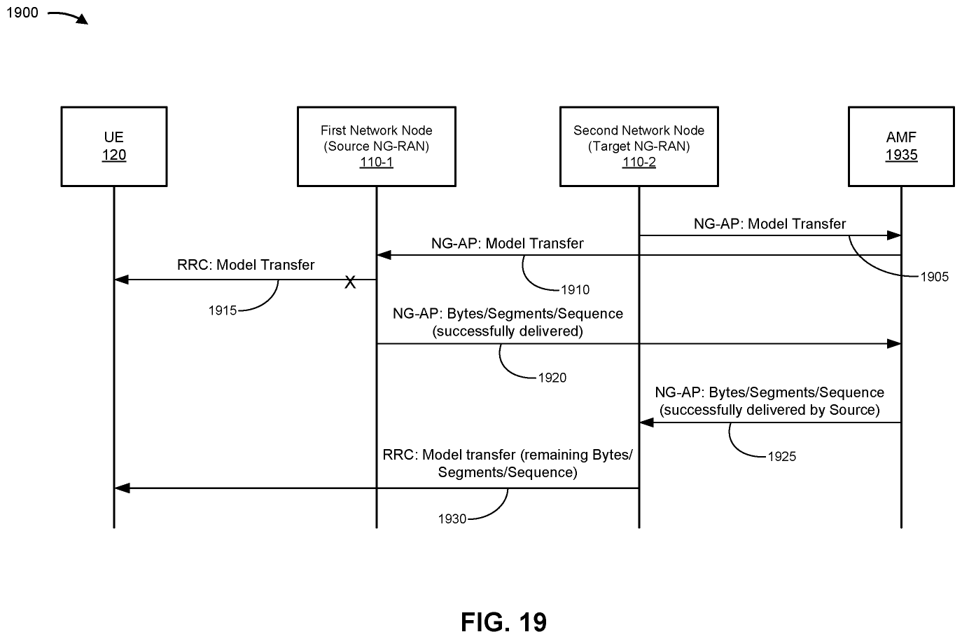

FIG. 19 is a diagram illustrating an example 1900 associated with AI/ML model delivery via RRC signaling, in accordance with the present disclosure. As shown in FIG. 19, a first network node 110-1, a second network node 110-2, and a UE 120 may communicate with one another. The first network node 110-1 may be part of a source NG-RAN in communication with the UE 120 prior to a handover execution. The second network node 110-2 may be part of a target NG-RAN in communication with the UE 120 after a handover procedure. The handover procedure may include a handover of the UE 120 from the source NG-RAN to the target NG-RAN. As shown by reference number 1905, the second network node 110-2 may transmit the AI/ML model to an AMF 1935 via an NG-AP. As shown by reference number 1910, the AMF 1935 may transmit, and the first network node 110-1 may receive, the model transfer (e.g., the transfer of the AI/ML model) via the NG-AP. As shown by reference number 1915, the first network node 110-1 attempts to transmit the AI/ML model to the UE 120 via RRC signaling but the model transfer at least partially fails. As shown by reference number 1920, the first network node 110-1 may indicate, to the AMF 1935, a byte, segment, or sequence number associated with the partial transmission of the AI/ML model. Accordingly, the indication, which may be transmitted to the AMF 1935 via NG-AP, shown by reference number 1920, may indicate to the AMF 1935, how much of the AI/ML model was received by the UE. As shown by reference number 1925, the AMF 1935 may transmit the remaining bytes, segment, or sequence of the AI/ML model to the second network node 110-2 via the NG-AP. As shown by reference number 1930, the second network node 110-2 may transmit the remaining bytes, segment, or sequence of the AI/ML model to the UE 120 via RRC signaling, resulting in a lossless model transfer during the NG-AP handover. As indicated above, FIG. 19 is provided as an example. Other examples may differ from what is described with respect to FIG. 19.

FIG. 20 is a diagram illustrating an example process 2000 performed, for example, by a UE, in accordance with the present disclosure. Example process 2000 is an example where the UE (e.g., UE 120) performs operations associated with RRC delivery of AI/ML models.

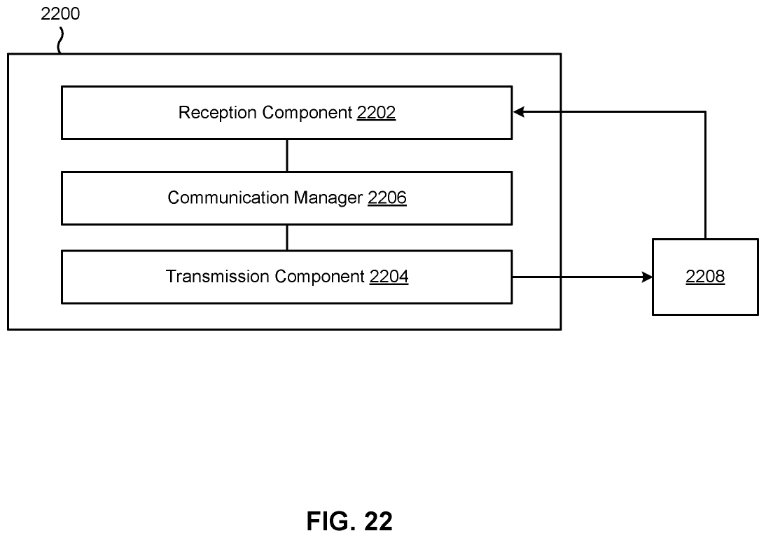

As shown in FIG. 20, in some aspects, process 2000 may include communicating with one of a first network node or a second network node to update available model information in a UE context at one or more of the first network node or the second network node (block 2010). For example, the UE (e.g., using reception component 2202, transmission component 2204, and/or communication manager 2206, depicted in FIG. 22) may communicate with one of a first network node or a second network node to update available model information in a UE context at one or more of the first network node or the second network node, as described above.

As further shown in FIG. 20, in some aspects, process 2000 may include receiving, from one of the first network node or the second network node, a model transfer via RRC signaling (block 2020). For example, the UE (e.g., using reception component 2202 and/or communication manager 2206, depicted in FIG. 22) may receive, from one of the first network node or the second network node, a model transfer via RRC signaling, as described above.

Process 2000 may include additional aspects, such as any single aspect or any combination of aspects described below and/or in connection with one or more other processes described elsewhere herein.

In a first aspect, process 2000 includes transmitting available model information to the first network node.

In a second aspect, alone or in combination with the first aspect, process 2000 includes receiving a model release instruction from the first network node.

In a third aspect, alone or in combination with one or more of the first and second aspects, process 2000 includes releasing one or more models indicated in the model release instruction.

In a fourth aspect, alone or in combination with one or more of the first through third aspects, process 2000 includes transmitting a model release request to the first network node.

In a fifth aspect, alone or in combination with one or more of the first through fourth aspects, receiving the model release instruction occurs after transmitting the model release request to the first network node.

In a sixth aspect, alone or in combination with one or more of the first through fifth aspects, process 2000 includes releasing one or more models without an indication from the first network node.

In a seventh aspect, alone or in combination with one or more of the first through sixth aspects, process 2000 includes transmitting available model information to the first network node, the model information indicating the one or more models available or released.

In an eighth aspect, alone or in combination with one or more of the first through seventh aspects, process 2000 includes receiving, from the first network node, a request for model information.

In a ninth aspect, alone or in combination with one or more of the first through eighth aspects, process 2000 includes transmitting the model information to the first network node in response to the request for model information.

In a tenth aspect, alone or in combination with one or more of the first through ninth aspects, process 2000 includes transmitting an RRC setup request, an RRC reestablishment request, or an RRC resume request to the second network node.

In an eleventh aspect, alone or in combination with one or more of the first through tenth aspects, receiving the model transfer includes receiving the model transfer from the second network node based, at least in part, on transmitting the RRC setup request, the RRC reestablishment request, or the RRC resume request to the second network node.

In a twelfth aspect, alone or in combination with one or more of the first through eleventh aspects, process 2000 includes receiving the model transfer from the second network node after completion of an RRC setup procedure, an RRC reestablishment procedure, or an RRC resume procedure.

In a thirteenth aspect, alone or in combination with one or more of the first through twelfth aspects, process 2000 includes transmitting an indication to update available model information in an RRC setup complete message, an RRC reestablishment complete message, or an RRC resume complete message prior to receiving the model transfer from the second network node.

In a fourteenth aspect, alone or in combination with one or more of the first through thirteenth aspects, communicating with one of the first network node or the second network node includes communicating with the first network node prior to a handover execution and communicating with the second network node after completion of the handover procedure.

In a fifteenth aspect, alone or in combination with one or more of the first through fourteenth aspects, receiving, from one of the first network node or the second network node, the model transfer includes receiving the model transfer from the first network node prior to the handover procedure.

In a sixteenth aspect, alone or in combination with one or more of the first through fifteenth aspects, process 2000 includes receiving an RRC reconfiguration signal from the first network node after completion of a model transfer procedure.

In a seventeenth aspect, alone or in combination with one or more of the first through sixteenth aspects, receiving, from one of the first network node or the second network node, the model transfer includes receiving the model transfer from the second network node after completion of the handover procedure.

In an eighteenth aspect, alone or in combination with one or more of the first through seventeenth aspects, process 2000 includes transmitting an RRC reconfiguration complete signal to the second network node to update available model information, wherein the model transfer is received from the second network node after transmitting the RRC reconfiguration complete signal.

In a nineteenth aspect, alone or in combination with one or more of the first through eighteenth aspects, process 2000 includes receiving a request for model information from the second network node after the handover procedure.

In a twentieth aspect, alone or in combination with one or more of the first through nineteenth aspects, process 2000 includes transmitting model information to the second network node based, at least in part, on receiving the request for model information from the second network node.

In a twenty-first aspect, alone or in combination with one or more of the first through twentieth aspects, process 2000 includes receiving a first configuration and a message via a first SRB.

In a twenty-second aspect, alone or in combination with one or more of the first through twenty-first aspects, receiving, from one of the first network node or the second network node, the model transfer via RRC signaling includes receiving the first configuration, the second configuration, and the model transfer from the first network node via the first SRB.

In a twenty-third aspect, alone or in combination with one or more of the first through twenty-second aspects, process 2000 includes receiving a second configuration from the first network node via the first SRB.

In a twenty-fourth aspect, alone or in combination with one or more of the first through twenty-third aspects, receiving, from one of the first network node or the second network node, the model transfer via RRC signaling includes receiving a first configuration and a second configuration from the first network node via the first SRB and the model transfer via a second SRB.

In a twenty-fifth aspect, alone or in combination with one or more of the first through twenty-fourth aspects, the first SRB has a higher priority than the second SRB.

In a twenty-sixth aspect, alone or in combination with one or more of the first through twenty-fifth aspects, receiving, from one of the first network node or the second network node, the model transfer via RRC signaling includes receiving the model transfer via a second SRB.

In a twenty-seventh aspect, alone or in combination with one or more of the first through twenty-sixth aspects, process 2000 includes receiving a second configuration via the first SRB when the model transfer cannot be completed before completion of a handover procedure.

In a twenty-eighth aspect, alone or in combination with one or more of the first through twenty-seventh aspects, process 2000 includes receiving at least a portion of a second configuration after receiving the model transfer.

In a twenty-ninth aspect, alone or in combination with one or more of the first through twenty-eighth aspects, the first SRB has a higher priority than the second SRB.

In a thirtieth aspect, alone or in combination with one or more of the first through twenty-ninth aspects, process 2000 includes receiving the model before receiving the first configuration.

In a thirty-first aspect, alone or in combination with one or more of the first through thirtieth aspects, process 2000 includes receiving an LCM control signal from the second network node.

In a thirty-second aspect, alone or in combination with one or more of the first through thirty-first aspects, receiving, from one of the first network node or the second network node, the model transfer via RRC signaling includes receiving at least a portion of the model transfer from the first network node and at least a portion of the model transfer from the second network node when the model transfer cannot be completed before completion of a handover procedure.

In a thirty-third aspect, alone or in combination with one or more of the first through thirty-second aspects, process 2000 includes receiving a second configuration from the first network node or from the second network node.

In a thirty-fourth aspect, alone or in combination with one or more of the first through thirty-third aspects, process 2000 includes applying the second configuration from the first network node until receiving an entirety of the model transfer.

Although FIG. 20 shows example blocks of process 2000, in some aspects, process 2000 may include additional blocks, fewer blocks, different blocks, or differently arranged blocks than those depicted in FIG. 20. Additionally, or alternatively, two or more of the blocks of process 2000 may be performed in parallel.

FIG. 21 is a diagram illustrating an example process 2100 performed, for example, by a network node, in accordance with the present disclosure. Example process 2100 is an example where the network node (e.g., network node 110) performs operations associated with RRC delivery of AI/ML models.

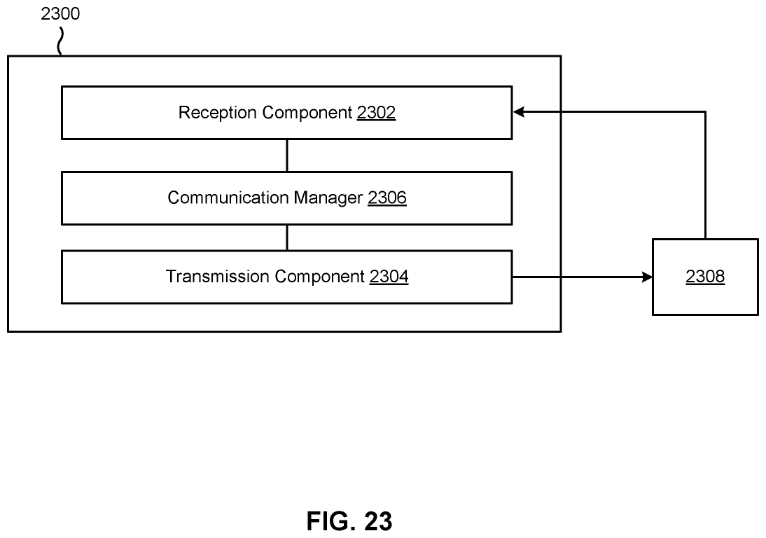

As shown in FIG. 21, in some aspects, process 2100 may include communicating with a UE (block 2110). For example, the network node (e.g., using reception component 2302, transmission component 2304, and/or communication manager 2306, depicted in FIG. 23) may communicate with a UE, as described above.

As further shown in FIG. 21, in some aspects, process 2100 may include outputting, to the UE, an AI/ML model transfer via RRC signaling (block 2120). For example, the network node (e.g., using transmission component 2304 and/or communication manager 2306, depicted in FIG. 23) may output, to the UE, an AI/ML model transfer via RRC signaling, as described above.

Process 2100 may include additional aspects, such as any single aspect or any combination of aspects described below and/or in connection with one or more other processes described elsewhere herein.

In a first aspect, process 2100 includes receiving AI/ML model information output by the UE.

In a second aspect, alone or in combination with the first aspect, process 2100 includes outputting an AI/ML model release instruction to the UE.

In a third aspect, alone or in combination with one or more of the first and second aspects, the AI/ML model release instruction configures the UE to release one or more AI/ML models.

In a fourth aspect, alone or in combination with one or more of the first through third aspects, process 2100 includes receiving an AI/ML model release request from the UE.

In a fifth aspect, alone or in combination with one or more of the first through fourth aspects, outputting the AI/ML model release instruction occurs based, at least in part, on receiving the AI/ML model release request.

In a sixth aspect, alone or in combination with one or more of the first through fifth aspects, process 2100 includes receiving AI/ML model information from the UE, the model information identifying one or more AI/ML models released by the UE.

In a seventh aspect, alone or in combination with one or more of the first through sixth aspects, process 2100 includes outputting, to the UE, a request for AI/ML model information.

In an eighth aspect, alone or in combination with one or more of the first through seventh aspects, process 2100 includes receiving the AI/ML model information based, at least in part, on outputting the request for AI/ML model information.

In a ninth aspect, alone or in combination with one or more of the first through eighth aspects, process 2100 includes receiving, from the UE, an RRC resume request.

In a tenth aspect, alone or in combination with one or more of the first through ninth aspects, outputting the model transfer includes outputting the AI/ML model transfer based, at least in part, on receiving the RRC resume request.

In an eleventh aspect, alone or in combination with one or more of the first through tenth aspects, process 2100 includes outputting an RRC resume signal or an RRC setup signal to the UE after receiving the RRC resume request and prior to outputting the AI/ML model transfer.

In a twelfth aspect, alone or in combination with one or more of the first through eleventh aspects, process 2100 includes receiving a UE context response.

In a thirteenth aspect, alone or in combination with one or more of the first through twelfth aspects, outputting the RRC resume signal or the RRC setup signal is based, at least in part, on receiving the UE context response.

In a fourteenth aspect, alone or in combination with one or more of the first through thirteenth aspects, process 2100 includes outputting an RRC resume complete signal or an RRC setup complete signal to the UE prior to outputting the AI/ML model transfer.

In a fifteenth aspect, alone or in combination with one or more of the first through fourteenth aspects, communicating with the UE occurs based, at least in part, on a handover procedure.

In a sixteenth aspect, alone or in combination with one or more of the first through fifteenth aspects, process 2100 includes outputting an RRC reconfiguration signal to the UE after completing a handover procedure.

In a seventeenth aspect, alone or in combination with one or more of the first through sixteenth aspects, outputting the model transfer includes outputting the model transfer after completing a handover procedure.

In an eighteenth aspect, alone or in combination with one or more of the first through seventeenth aspects, process 2100 includes receiving an RRC reconfiguration complete signal, wherein the AI/ML model transfer is output to the UE based, at least in part, on receiving the RRC reconfiguration complete signal.

In a nineteenth aspect, alone or in combination with one or more of the first through eighteenth aspects, process 2100 includes outputting a request for AI/ML model information to the UE after completing a handover procedure.

In a twentieth aspect, alone or in combination with one or more of the first through nineteenth aspects, process 2100 includes receiving AI/ML model information based, at least in part, on outputting the request for AI/ML model information.

In a twenty-first aspect, alone or in combination with one or more of the first through twentieth aspects, process 2100 includes outputting, to the UE, a first configuration via a first SRB.

In a twenty-second aspect, alone or in combination with one or more of the first through twenty-first aspects, outputting, to the UE, the AI/ML model transfer via RRC signaling includes outputting the AI/ML model transfer to the UE via the first SRB.

In a twenty-third aspect, alone or in combination with one or more of the first through twenty-second aspects, process 2100 includes outputting a second configuration to the UE via the first SRB.

In a twenty-fourth aspect, alone or in combination with one or more of the first through twenty-third aspects, outputting, to the UE, the AI/ML model transfer via RRC signaling includes outputting a second configuration via the first SRB and the AI/ML model transfer via a second SRB.

In a twenty-fifth aspect, alone or in combination with one or more of the first through twenty-fourth aspects, the first SRB has a higher priority than the second SRB.

In a twenty-sixth aspect, alone or in combination with one or more of the first through twenty-fifth aspects, outputting, to the UE, the AI/ML model transfer via RRC signaling includes outputting the model transfer via a second SRB.

In a twenty-seventh aspect, alone or in combination with one or more of the first through twenty-sixth aspects, outputting the first configuration includes outputting at least a portion of the first configuration via the first SRB.

In a twenty-eighth aspect, alone or in combination with one or more of the first through twenty-seventh aspects, process 2100 includes outputting at least a portion of a second configuration after outputting the model transfer.

In a twenty-ninth aspect, alone or in combination with one or more of the first through twenty-eighth aspects, the first SRB has a higher priority than the second SRB.

In a thirtieth aspect, alone or in combination with one or more of the first through twenty-ninth aspects, outputting the AI/ML model transfer occurs before outputting the first configuration.

In a thirty-first aspect, alone or in combination with one or more of the first through thirtieth aspects, outputting, to the UE, the AI/ML model transfer via RRC signaling includes outputting at least a portion of the AI/ML model transfer.

In a thirty-second aspect, alone or in combination with one or more of the first through thirty-first aspects, process 2100 includes outputting an LCM control signal.

In a thirty-third aspect, alone or in combination with one or more of the first through thirty-second aspects, process 2100 includes determining an incomplete AI/ML model transfer to the UE.

In a thirty-fourth aspect, alone or in combination with one or more of the first through thirty-third aspects, process 2100 includes outputting, to a target network node, an incomplete model transfer indication based, at least in part, on determining the incomplete AI/ML model transfer to the UE.

In a thirty-fifth aspect, alone or in combination with one or more of the first through thirty-fourth aspects, process 2100 includes outputting, to an AMF, an incomplete AI/ML model transfer indication based, at least in part, on determining the incomplete AI/ML model transfer to the UE.

In a thirty-sixth aspect, alone or in combination with one or more of the first through thirty-fifth aspects, process 2100 includes updating available AI/ML model information in a UE context at one or more of the UE or the network node.

Although FIG. 21 shows example blocks of process 2100, in some aspects, process 2100 may include additional blocks, fewer blocks, different blocks, or differently arranged blocks than those depicted in FIG. 21. Additionally, or alternatively, two or more of the blocks of process 2100 may be performed in parallel.

FIG. 22 is a diagram of an example apparatus 2200 for wireless communication, in accordance with the present disclosure. The apparatus 2200 may be a UE, or a UE may include the apparatus 2200. In some aspects, the apparatus 2200 includes a reception component 2202, a transmission component 2204, and/or a communication manager 2206, which may be in communication with one another (for example, via one or more buses and/or one or more other components). In some aspects, the communication manager 2206 is the communication manager 140 described in connection with FIG. 1. As shown, the apparatus 2200 may communicate with another apparatus 2208, such as a UE or a network node (such as a CU, a DU, an RU, or a base station), using the reception component 2202 and the transmission component 2204.

In some aspects, the apparatus 2200 may be configured to perform one or more operations described herein in connection with FIGS. 4-19. Additionally, or alternatively, the apparatus 2200 may be configured to perform one or more processes described herein, such as process 2000 of FIG. 20. In some aspects, the apparatus 2200 and/or one or more components shown in FIG. 22 may include one or more components of the UE described in connection with FIG. 2. Additionally, or alternatively, one or more components shown in FIG. 22 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 2202 may receive communications, such as reference signals, control information, data communications, or a combination thereof, from the apparatus 2208. The reception component 2202 may provide received communications to one or more other components of the apparatus 2200. In some aspects, the reception component 2202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 2200. In some aspects, the reception component 2202 may include one or more antennas, a modem, a demodulator, a MIMO detector, a receive processor, a controller/processor, a memory, or a combination thereof, of the UE described in connection with FIG. 2.

The transmission component 2204 may transmit communications, such as reference signals, control information, data communications, or a combination thereof, to the apparatus 2208. In some aspects, one or more other components of the apparatus 2200 may generate communications and may provide the generated communications to the transmission component 2204 for transmission to the apparatus 2208. In some aspects, the transmission component 2204 may perform signal processing on the generated communications (such as filtering, amplification, modulation, digital-to-analog conversion, multiplexing, interleaving, mapping, or encoding, among other examples), and may transmit the processed signals to the apparatus 2208. In some aspects, the transmission component 2204 may include one or more antennas, a modem, a modulator, a transmit MIMO processor, a transmit processor, a controller/processor, a memory, or a combination thereof, of the UE described in connection with FIG. 2. In some aspects, the transmission component 2204 may be co-located with the reception component 2202 in a transceiver.

The communication manager 2206 may support operations of the reception component 2202 and/or the transmission component 2204. For example, the communication manager 2206 may receive information associated with configuring reception of communications by the reception component 2202 and/or transmission of communications by the transmission component 2204. Additionally, or alternatively, the communication manager 2206 may generate and/or provide control information to the reception component 2202 and/or the transmission component 2204 to control reception and/or transmission of communications.

The reception component 2202 and/or the transmission component 2204 may communicate with one of a first network node or a second network node to update available model information in a UE context at one or more of the first network node or the second network node. The reception component 2202 may receive, from one of the first network node or the second network node, a model transfer via RRC signaling.

The transmission component 2204 may transmit the model information to the first network node. The reception component 2202 may receive a model release instruction from the first network node. The communication manager 2206 may release one or more models indicated in the model release instruction. The communication manager 2206 may release one or more models without an indication from the first network node. The transmission component 2204 may transmit updated model information to the first network node, the updated model information indicating the one or more models available or released. The reception component 2202 may receive, from the first network node, a request for available model information. The transmission component 2204 may transmit the model information to the first network node in response to the request for model information. The transmission component 2204 may transmit an RRC resume request to the second network node. The reception component 2202 may receive an RRC resume signal or an RRC setup signal from the second network node after transmitting the RRC resume request to the second network node and prior to receiving the model transfer from the second network node. The transmission component 2204 may transmit an indication to update available model information in an RRC setup complete message, an RRC reestablishment complete message, or an RRC resume complete message prior to receiving the model transfer from the second network node. The reception component 2202 may receive an RRC reconfiguration signal from the first network node after completion of a model transfer procedure. The transmission component 2204 may transmit an RRC reconfiguration complete signal to the second network node to update available model information, wherein the model transfer is received from the second network node after transmitting the RRC reconfiguration complete signal. The reception component 2202 may receive a request for model information from the second network node after the handover procedure. The transmission component 2204 may transmit model information to the second network node based, at least in part, on receiving the request for model information from the second network node. The reception component 2202 may receive a first configuration via a first SRB. The reception component 2202 may receive a second configuration from the first network node via the first SRB. The reception component 2202 may receive at least a portion of a second configuration after receiving the model transfer. The reception component 2202 may receive an LCM control signal from the second network node. The reception component 2202 may receive a second configuration from the first network node or from the second network node. The communication manager 2206 may apply the second configuration from the first network node until receiving an entirety of the model transfer.

The number and arrangement of components shown in FIG. 22 are provided as an example. In practice, there may be additional components, fewer components, different components, or differently arranged components than those shown in FIG. 22. Furthermore, two or more components shown in FIG. 22 may be implemented within a single component, or a single component shown in FIG. 22 may be implemented as multiple, distributed components. Additionally, or alternatively, a set of (one or more) components shown in FIG. 22 may perform one or more functions described as being performed by another set of components shown in FIG. 22.

FIG. 23 is a diagram of an example apparatus 2300 for wireless communication, in accordance with the present disclosure. The apparatus 2300 may be a network node, or a network node may include the apparatus 2300. In some aspects, the apparatus 2300 includes a reception component 2302, a transmission component 2304, and/or a communication manager 2306, which may be in communication with one another (for example, via one or more buses and/or one or more other components). In some aspects, the communication manager 2306 is the communication manager 150 described in connection with FIG. 1. As shown, the apparatus 2300 may communicate with another apparatus 2308, such as a UE or a network node (such as a CU, a DU, an RU, or a base station), using the reception component 2302 and the transmission component 2304.

In some aspects, the apparatus 2300 may be configured to perform one or more operations described herein in connection with FIGS. 4-19. Additionally, or alternatively, the apparatus 2300 may be configured to perform one or more processes described herein, such as process 2100 of FIG. 21. In some aspects, the apparatus 2300 and/or one or more components shown in FIG. 23 may include one or more components of the network node described in connection with FIG. 2. Additionally, or alternatively, one or more components shown in FIG. 23 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 2302 may receive communications, such as reference signals, control information, data communications, or a combination thereof, from the apparatus 2308. The reception component 2302 may provide received communications to one or more other components of the apparatus 2300. In some aspects, the reception component 2302 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 2300. In some aspects, the reception component 2302 may include one or more antennas, a modem, a demodulator, a MIMO detector, a receive processor, a controller/processor, a memory, or a combination thereof, of the network node described in connection with FIG. 2. In some aspects, the reception component 2302 and/or the transmission component 2304 may include or may be included in a network interface. The network interface may be configured to obtain and/or output signals for the apparatus 2300 via one or more communications links, such as a backhaul link, a midhaul link, and/or a fronthaul link

The transmission component 2304 may transmit communications, such as reference signals, control information, data communications, or a combination thereof, to the apparatus 2308. In some aspects, one or more other components of the apparatus 2300 may generate communications and may provide the generated communications to the transmission component 2304 for transmission to the apparatus 2308. In some aspects, the transmission component 2304 may perform signal processing on the generated communications (such as filtering, amplification, modulation, digital-to-analog conversion, multiplexing, interleaving, mapping, or encoding, among other examples), and may transmit the processed signals to the apparatus 2308. In some aspects, the transmission component 2304 may include one or more antennas, a modem, a modulator, a transmit MIMO processor, a transmit processor, a controller/processor, a memory, or a combination thereof, of the network node described in connection with FIG. 2. In some aspects, the transmission component 2304 may be co-located with the reception component 2302 in a transceiver.

The communication manager 2306 may support operations of the reception component 2302 and/or the transmission component 2304. For example, the communication manager 2306 may receive information associated with configuring reception of communications by the reception component 2302 and/or transmission of communications by the transmission component 2304. Additionally, or alternatively, the communication manager 2306 may generate and/or provide control information to the reception component 2302 and/or the transmission component 2304 to control reception and/or transmission of communications.

The reception component 2302 and/or the transmission component 2304 may communicate with a UE. The transmission component 2304 may output, to the UE, a model transfer via RRC signaling. The reception component 2302 may receive model information output by the UE. The transmission component 2304 may output a model release instruction to the UE. The reception component 2302 may receive a model release request from the UE. The reception component 2302 may receive model information from the UE, the model information identifying one or more models released by the UE. The transmission component 2304 may output, to the UE, a request for model information. The reception component 2302 may receive the model information based, at least in part, on outputting the request for model information. The reception component 2302 may receive, from the UE, an RRC resume request. The transmission component 2304 may output an RRC resume signal or an RRC setup signal to the UE after receiving the RRC resume request and prior to outputting the model transfer. The reception component 2302 may receive a UE context response. The transmission component 2304 may output an RRC resume complete signal or an RRC setup complete signal to the UE prior to outputting the model transfer. The transmission component 2304 may output an RRC reconfiguration signal to the UE after completing a handover procedure. The reception component 2302 may receive an RRC reconfiguration complete signal, wherein the model transfer is output to the UE based, at least in part, on receiving the RRC reconfiguration complete signal. The transmission component 2304 may output a request for model information to the UE after completing a handover procedure.

The reception component 2302 may receive model information based, at least in part, on outputting the request for model information. The transmission component 2304 may output, to the UE, a first configuration via a first SRB. The transmission component 2304 may output a second configuration to the UE via the first SRB. The transmission component 2304 may output at least a portion of a second configuration after outputting the model transfer. The transmission component 2304 may output an LCM control signal. The communication manager 2306 may determine an incomplete model transfer to the UE. The transmission component 2304 may output, to a target network node, an incomplete model transfer indication based, at least in part, on determining the incomplete model transfer to the UE. The transmission component 2304 may output, to an AMF, an incomplete model transfer indication based, at least in part, on determining the incomplete model transfer to the UE. The communication manager 2306 may update available model information in a UE context at one or more of the UE or the network node.

The number and arrangement of components shown in FIG. 23 are provided as an example. In practice, there may be additional components, fewer components, different components, or differently arranged components than those shown in FIG. 23. Furthermore, two or more components shown in FIG. 23 may be implemented within a single component, or a single component shown in FIG. 23 may be implemented as multiple, distributed components. Additionally, or alternatively, a set of (one or more) components shown in FIG. 23 may perform one or more functions described as being performed by another set of components shown in FIG. 23.

The following provides an overview of some Aspects of the present disclosure:

Aspect 1: A method of wireless communication performed by a UE, comprising: communicating with one of a first network node or a second network node to update available model information in a UE context at one or more of the first network node or the second network node; and receiving, from one of the first network node or the second network node, a model transfer via RRC signaling.

Aspect 2: The method of Aspect 1, further comprising transmitting the model information to the first network node.

Aspect 3: The method of Aspect 2, further comprising receiving a model release instruction from the first network node.

Aspect 4: The method of Aspect 3, further comprising releasing one or more models indicated in the model release instruction.

Aspect 5: The method of Aspect 3, further comprising transmitting a model release request to the first network node.

Aspect 6: The method of Aspect 5, wherein receiving the model release instruction occurs after transmitting the model release request to the first network node.

Aspect 7: The method of any of Aspects 1-6, further comprising releasing one or more models without an indication from the first network node.

Aspect 8: The method of Aspect 7, further comprising transmitting available model information to the first network node, the model information indicating the one or more models available or released.

Aspect 9: The method of any of Aspects 1-8, further comprising receiving, from the first network node, a request for model information.

Aspect 10: The method of Aspect 9, further comprising transmitting the model information to the first network node in response to the request for model information.

Aspect 11: The method of any of Aspects 1-10, further comprising transmitting an RRC resume request to the second network node.

Aspect 12: The method of Aspect 11, wherein receiving the model transfer includes receiving the model transfer from the second network node based, at least in part, on transmitting the RRC resume request to the second network node.

Aspect 13: The method of Aspect 12, further comprising receiving the model transfer from the second network node after completion of an RRC setup procedure, an RRC reestablishment procedure, or an RRC resume procedure.

Aspect 14: The method of Aspect 12, further comprising transmitting an indication to update available model information in an RRC setup complete message, an RRC reestablishment complete message, or an RRC resume complete message to the second network node prior to receiving the model transfer from the second network node.

Aspect 15: The method of any of Aspects 1-14, wherein communicating with one of the first network node or the second network node includes communicating with the first network node prior to a handover execution and communicating with the second network node after completion of the handover procedure.

Aspect 16: The method of Aspect 15, wherein receiving, from one of the first network node or the second network node, the model transfer includes receiving the model transfer from the first network node prior to the handover procedure.

Aspect 17: The method of Aspect 15, further comprising receiving an RRC reconfiguration signal from the first network node after completion of a model transfer procedure.

Aspect 18: The method of Aspect 15, wherein receiving, from one of the first network node or the second network node, the model transfer includes receiving the model transfer from the second network node after the handover procedure.

Aspect 19: The method of Aspect 18, further comprising transmitting an RRC reconfiguration complete signal to the second network node to update available model information, wherein the model transfer is received from the second network node after transmitting the RRC reconfiguration complete signal.

Aspect 20: The method of Aspect 15, further comprising receiving a request for model information from the second network node after the handover procedure.

Aspect 21: The method of Aspect 20, further comprising transmitting model information to the second network node based, at least in part, on receiving the request for model information from the second network node.

Aspect 22: The method of any of Aspects 1-21, further comprising receiving a first configuration via a first SRB.

Aspect 23: The method of Aspect 22, wherein receiving, from one of the first network node or the second network node, the model transfer via RRC signaling includes receiving the first configuration, the second configuration, and the model transfer from the first network node via the first SRB.

Aspect 24: The method of Aspect 23, further comprising receiving a second configuration from the first network node via the first SRB.

Aspect 25: The method of Aspect 22, wherein receiving, from one of the first network node or the second network node, the model transfer via RRC signaling includes receiving a first configuration and a second configuration from the first network node via the first SRB and the model transfer via a second SRB.

Aspect 26: The method of Aspect 25, wherein the first SRB has a higher priority than the second SRB.

Aspect 27: The method of Aspect 22, wherein receiving, from one of the first network node or the second network node, the model transfer via RRC signaling includes receiving the model transfer via a second SRB.

Aspect 28: The method of Aspect 27, wherein receiving the first configuration includes receiving the second configuration via the first SRB when the model transfer cannot be completed before completion of a handover procedure.

Aspect 29: The method of Aspect 28, further comprising receiving at least a portion of a second configuration after receiving the model transfer.

Aspect 30: The method of Aspect 28, wherein the first SRB has a higher priority than the second SRB.

Aspect 31: The method of Aspect 22, wherein receiving the model occurs before receiving the first configuration.

Aspect 32: The method of Aspect 24, further comprising receiving an LCM control signal from the second network node.

Aspect 33: The method of Aspect 22, wherein receiving, from one of the first network node or the second network node, the model transfer via RRC signaling includes receiving at least a portion of the model transfer from the first network node and at least a portion of the model transfer from the second network node when the model transfer cannot be completed before completion of a handover procedure.

Aspect 34: The method of Aspect 33, further comprising receiving a second configuration from the first network node or from the second network node.

Aspect 35: The method of Aspect 34, further comprising applying the second configuration from the first network node until receiving an entirety of the model transfer.

Aspect 36: A method of wireless communication performed by a network node, comprising: communicating with a UE; and outputting, to the UE, an AI/ML model transfer via RRC signaling.

Aspect 37: The method of Aspect 36, further comprising receiving AI/ML model information output by the UE.

Aspect 38: The method of Aspect 37, further comprising outputting an AI/ML model release instruction to the UE.

Aspect 39: The method of Aspect 38, wherein the AI/ML model release instruction configures the UE to release one or more AI/ML models.

Aspect 40: The method of Aspect 38, further comprising receiving an AI/ML model release request from the UE.

Aspect 41: The method of Aspect 40, wherein outputting the AI/ML model release instruction occurs based, at least in part, on receiving the AI/ML model release request.

Aspect 42: The method of any of Aspects 36-41, further comprising receiving model information from the UE, the AI/ML model information identifying one or more AI/ML models released by the UE.

Aspect 43: The method of any of Aspects 36-42, further comprising outputting, to the UE, a request for AI/ML model information.

Aspect 44: The method of Aspect 43, further comprising receiving the AI/ML model information based, at least in part, on outputting the request for AI/ML model information.

Aspect 45: The method of any of Aspects 36-44, further comprising receiving, from the UE, an RRC resume request.

Aspect 46: The method of Aspect 45, wherein outputting the AI/ML model transfer includes outputting the AI/ML model transfer based, at least in part, on receiving the RRC resume request.

Aspect 47: The method of Aspect 46, further comprising outputting an RRC resume signal or an RRC setup signal to the UE after receiving the RRC resume request and prior to outputting the AI/ML model transfer.

Aspect 48: The method of Aspect 47, further comprising receiving a UE context response.

Aspect 49: The method of Aspect 48, wherein outputting the RRC resume signal or the RRC setup signal is based, at least in part, on receiving the UE context response.

Aspect 50: The method of Aspect 46, further comprising outputting an RRC resume complete signal or an RRC setup complete signal to the UE prior to outputting the AI/ML model transfer.

Aspect 51: The method of any of Aspects 36-50, wherein communicating with the UE occurs based, at least in part, on a handover procedure.

Aspect 52: The method of Aspect 51, further comprising outputting an RRC reconfiguration signal to the UE after completing a handover procedure.

Aspect 53: The method of Aspect 51, wherein outputting the AI/ML model transfer includes outputting the AI/ML model transfer after completing a handover procedure.

Aspect 54: The method of Aspect 53, further comprising receiving an RRC reconfiguration complete signal, wherein the AI/ML model transfer is output to the UE based, at least in part, on receiving the RRC reconfiguration complete signal.

Aspect 55: The method of Aspect 51, further comprising outputting a request for AI/ML model information to the UE after completing a handover procedure.

Aspect 56: The method of Aspect 55, further comprising receiving AI/ML model information based, at least in part, on outputting the request for AI/ML model information.

Aspect 57: The method of any of Aspects 36-56, further comprising outputting, to the UE, a first configuration via a first SRB.

Aspect 58: The method of Aspect 57, wherein outputting, to the UE, the AI/ML model transfer via RRC signaling includes outputting the AI/ML model transfer to the UE via the first SRB.

Aspect 59: The method of Aspect 58, further comprising outputting a second configuration to the UE via the first SRB.

Aspect 60: The method of Aspect 57, wherein outputting, to the UE, the AI/ML model transfer via RRC signaling includes outputting a first configuration and a second configuration via the first SRB and the AI/ML model transfer via a second SRB.

Aspect 61: The method of Aspect 60, wherein the first SRB has a higher priority than the second SRB.

Aspect 62: The method of Aspect 57, wherein outputting, to the UE, the AI/ML model transfer via RRC signaling includes outputting the model transfer via a second SRB.

Aspect 63: The method of Aspect 62, wherein outputting the first configuration includes outputting at least a portion of the first configuration via the first SRB.

Aspect 64: The method of Aspect 63, further comprising outputting at least a portion of a second configuration after outputting the AI/ML model transfer.

Aspect 65: The method of Aspect 63, wherein the first SRB has a higher priority than the second SRB.

Aspect 66: The method of Aspect 57, wherein outputting the model transfer occurs before outputting the first configuration.

Aspect 67: The method of any of Aspects 36-66, wherein outputting, to the UE, the AI/ML model transfer via RRC signaling includes outputting at least a portion of the AI/ML model transfer.

Aspect 68: The method of any of Aspects 36-67, further comprising outputting an LCM control signal.

Aspect 69: The method of Aspect 38, further comprising determining an incomplete AI/ML model transfer to the UE.

Aspect 70: The method of Aspect 69, further comprising outputting, to a target network node, an incomplete AI/ML model transfer indication based, at least in part, on determining the incomplete AI/ML model transfer to the UE.

Aspect 71: The method of Aspect 69, further comprising outputting, to an access and mobility management function (AMF), an incomplete AI/ML model transfer indication based, at least in part, on determining the incomplete AI/ML model transfer to the UE.

Aspect 72: The method of any of Aspects 36-71, further comprising updating available model information in a UE context at one or more of the UE or the network node.

Aspect 73: An apparatus for wireless communication at a device, comprising a processor; memory coupled with the processor; and instructions stored in the memory and executable by the processor to cause the apparatus to perform the method of one or more of Aspects 1-72.

Aspect 74: A device for wireless communication, comprising a memory and one or more processors coupled to the memory, the one or more processors configured to perform the method of one or more of Aspects 1-72.

Aspect 75: An apparatus for wireless communication, comprising at least one means for performing the method of one or more of Aspects 1-72.

Aspect 76: A non-transitory computer-readable medium storing code for wireless communication, the code comprising instructions executable by a processor to perform the method of one or more of Aspects 1-72.

Aspect 77: A non-transitory computer-readable medium storing a set of instructions for wireless communication, the set of instructions comprising one or more instructions that, when executed by one or more processors of a device, cause the device to perform the method of one or more of Aspects 1-72.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A user equipment (UE) for wireless communication, comprising:
a memory; and
one or more processors, coupled to the memory, configured to:
communicate with one of a first network node or a second network node to update available model information in a UE context at one or more of the first network node or the second network node; and
receive, from one of the first network node or the second network node, a model transfer via radio resource control (RRC) signaling.

2. The UE of claim 1, wherein the one or more processors are further configured to transmit available model information to the first network node.

3. The UE of claim 1, wherein the one or more processors are further configured to receive a model release instruction from the first network node.

4. The UE of claim 3, wherein the one or more processors are further configured to release one or more models indicated in the model release instruction.

5. The UE of claim 3, wherein the one or more processors are further configured to:
transmit a model release request to the first network node,
wherein receiving the model release instruction occurs after transmitting the model release request to the first network node.

6. The UE of claim 1, wherein the one or more processors are further configured to:
release one or more models without an indication from the first network node; and
transmit updated model information to the first network node, the updated model information indicating the one or more models are available or released.

7. The UE of claim 1, wherein the RRC signaling includes one or more of an RRC setup message, an RRC reestablishment message, or an RRC resume message, and wherein the one or more processors, to receive the model transfer via the RRC signaling are configured to receive the model transfer from the second network node as a result of transmitting an RRC setup request, an RRC reestablishment request, or an RRC resume request to the second network node.

8. The UE of claim 7, wherein the one or more processors are further configured to receive the model transfer from the second network node after completion of an RRC setup procedure, an RRC reestablishment procedure, or an RRC resume procedure.

9. The UE of claim 7, wherein the one or more processors are further configured to transmit an indication to update available model information in an RRC setup complete message, an RRC reestablishment complete message, or an RRC resume complete message prior to receiving the model transfer from the second network node.

10. The UE of claim 1, wherein the one or more processors, to communicate with one of the first network node or the second network node, are configured to communicate with the first network node prior to a handover execution and communicate with the second network node after the handover execution,
the communications with the first network node and the communications with the second network node including model transfer information.

11. The UE of claim 10, wherein the one or more processors, to receive the model transfer from one of the first network node or the second network node, are configured to receive the model from the first network node prior to the handover execution.

12. The UE of claim 10, wherein the one or more processors are further configured to receive an RRC reconfiguration signal from the first network node after completion of a model transfer procedure.

13. The UE of claim 10, wherein the one or more processors, to receive the model transfer from one of the first network node or the second network node, are configured to:
receive the model from the second network node after the handover execution; and
transmit an RRC reconfiguration complete signal to the second network node to update available model information,
wherein the model is received from the second network node after transmitting the RRC reconfiguration complete signal.

14. The UE of claim 10, wherein the one or more processors are further configured to:
receive a request for available model information from the second network node after the handover execution; and
transmit the available model information to the second network node based, at least in part, on receiving the request for model information from the second network node.

15. The UE of claim 10, wherein the one or more processors are configured to receive a life cycle management control signal from the second network node following the handover execution from the first network node to the second network node.

16. The UE of claim 1, wherein the one or more processors are further configured to receive a first configuration and a message via a first signaling radio bearer (SRB).

17. The UE of claim 16, wherein the one or more processors, to receive the model transfer from one of the first network node or the second network node via RRC signaling, are configured to:
receive a second configuration from the first network node; and
apply the second configuration from the first network node until receiving an entirety of the model transfer.

18. The UE of claim 16, wherein the one or more processors, to receive the model transfer from one of the first network node or the second network node via RRC signaling, are configured to receive the first configuration, a second configuration, and the model transfer from the first network node via the first SRB.

19. The UE of claim 16, wherein the one or more processors, to receive, from one of the first network node or the second network node, the model transfer via RRC signaling, are configured to receive a first configuration and a second configuration from the first network node via the first SRB and the model transfer via a second SRB.

20. The UE of claim 16, wherein the one or more processors are configured to receive a second configuration via the first SRB when the model transfer cannot be completed before execution of a handover procedure.

21. The UE of claim 16, wherein the one or more processors, to receive the model transfer from one of the first network node or the second network node via RRC signaling, are configured to receive at least a portion of the model transfer from the first network node and at least a portion of the model transfer from the second network node when the model transfer cannot be completed before execution of a handover procedure.

22. The UE of claim 16, wherein the one or more processors are configured to receive the model before receiving the first configuration.

23. A network node for wireless communication, comprising:
a memory; and
one or more processors, coupled to the memory, configured to:
communicate with a user equipment (UE);
output, to the UE, an artificial intelligence or machine learning (AI/ML) model transfer via radio resource control (RRC) signaling;
receive an AI/ML model release request from the UE; and
output an AI/ML model release instruction to the UE to configure the UE to release one or more AI/ML models.

24. The network node of claim 23, wherein the one or more processors are further configured to output, to the UE, a first configuration and a message via a first signaling radio bearer (SRB),
wherein the one or more processors, to output the AI/ML model transfer to the UE via RRC signaling, are configured to output the AI/ML model transfer to the UE via the first SRB.

25. The network node of claim 23, wherein the one or more processors, to output the AI/ML model transfer to the UE via RRC signaling, are configured to output at least a portion of the model transfer.

26. A method of wireless communication performed by a user equipment (UE), comprising:
communicating with one of a first network node or a second network node to update available artificial intelligence or machine learning (AI/ML) model information in a UE context at one or more of the first network node or the second network node; and
receiving, from one of the first network node or the second network node, an AI/ML model transfer via radio resource control (RRC) signaling.

27. The method of claim 26, further comprising:
transmitting an AI/ML model release request to the first network node; and
receiving an AI/ML model release instruction after transmitting the AI/ML model release request to the first network node.

28. The method of claim 26, wherein receiving the AI/ML model transfer from one of the first network node or the second network node includes:
receiving a configuration from the first network node; and
applying the configuration from the first network node until receiving an entirety of the AI/ML model transfer.

29. A method of wireless communication performed by a network node, comprising:
communicating with a user equipment (UE);
outputting, to the UE, an artificial intelligence or machine learning (AI/ML) model transfer via radio resource control (RRC) signaling;
receiving an AI/ML model release request from the UE; and
outputting an AI/ML model release instruction to the UE,
wherein the AI/ML model release instruction configures the UE to release one or more AI/ML models.

30. The method of claim 29, further comprising configuring the UE to:
receive a configuration; and
apply the configuration until the UE receives an entirety of the AI/ML model transfer.
